(19) United States
(12) Patent Application Publication
(10) Pub. No.: US 2025/0370373 A1
(43) Pub. Date: Dec. 4, 2025

(54) IMAGE FORMING APPARATUS

(71) Applicants: Masatoshi MURAKAMI, Kanagawa (JP); Ryotaro KONNO, Tokyo (JP)

(72) Inventors: Masatoshi MURAKAMI, Kanagawa (JP); Ryotaro KONNO, Tokyo (JP)

(21) Appl. No.: 19/221,523

(22) Filed: May 29, 2025

(30) Foreign Application Priority Data
May 31, 2024 (JP) 2024-089538

(51) Int. Cl. G03G 15/043; G03G 15/00; G03G 15/04

(52) U.S. Cl. CPC G03G 15/0435; G03G 15/04036; G03G 15/5033; G03G 2215/0158; G03G 2215/0404

(57) ABSTRACT

An image forming apparatus includes a light emitter; a photoconductor to form a latent image on a surface of the photoconductor; a deflector to deflect light at a write start timing; an optical sensor; and circuitry. The optical sensor detects the scanning light scanning, with one of multiple sensitivities. The circuitry adjusts a light intensity of the emitted light and the write start timing based on the detection signal; switches from the one of multiple sensitivities to other of multiple sensitivities or from the other of multiple sensitivities to the one of multiple sensitivities based on the light intensity adjusted; and determines whether to perform a color misregistration correction based on a shift in the write start timing caused by a switch from the one of multiple sensitivities to the other of multiple sensitivities or from the other of multiple sensitivities to the one of multiple sensitivities.

### CROSS-REFERENCE TO RELATED APPLICATIONS

This patent application is based on and claims priority pursuant to 35 U.S.C. § 119(a) to Japanese Patent Application No. 2024-089538, filed on May 31, 2024, in the Japan Patent Office, the entire disclosure of which is hereby incorporated by reference herein.

### BACKGROUND

### Technical Field

The present disclosure relates to an image forming apparatus.

### Related Art

Electrophotographic image forming apparatuses have been proposed that expose a photoconductor using a laser diode.

### SUMMARY

The present disclosure described herein provides An image forming apparatus includes a light emitter to emit light; a photoconductor to form a latent image on a surface of the photoconductor by the light emitted from the light emitter; a deflector to deflect the light emitted from the light emitter to scan the light on the surface of the photoconductor at a write start timing; an optical sensor; and circuitry. The optical sensor detects the light scanning on the surface of the photoconductor with one of multiple sensitivities; and outputs a detection signal corresponding to a light intensity of the light detected by the optical sensor. The circuitry adjusts a light intensity of the light emitted from the light emitter and the write start timing based on the detection signal; switches from the one of multiple sensitivities to other of multiple sensitivities or from the other of multiple sensitivities to the one of multiple sensitivities based on the light intensity adjusted; and determines whether to perform a color misregistration correction based on a shift in the write start timing caused by a switch from the one of multiple sensitivities to the other of multiple sensitivities or from the other of multiple sensitivities to the one of multiple sensitivities.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a configuration of an image forming apparatus according to a first embodiment;

FIG. 2 is a diagram illustrating an operation of forming a color registration pattern to correct color misregistration in the image forming apparatus of FIG. 1;

FIG. 3 is a diagram illustrating a scanning operation of a laser beam in the image forming apparatus of FIG. 1;

FIG. 4 is a diagram illustrating a laser beam entering an optical sensor in the image forming apparatus of FIG. 1;

FIG. 5 is a diagram illustrating a detection signal and an output signal in the optical sensor of the image forming apparatus in FIG. 1;

FIG. 6 is a diagram illustrating a configuration of an optical scanner in the image forming apparatus of FIG. 1;

FIGS. 7A, 7B, and 7C are diagrams illustrating the relation between the intensity of a laser beam incident on the optical sensor and its detection and output signals in the image forming apparatus of FIG. 1;

FIG. 8 is a diagram illustrating a configuration of a synchronous detection board in the image forming apparatus of FIG. 1;

FIG. 9 is a block diagram of a functional configuration of a controller in the image forming apparatus of FIG. 1;

FIGS. 10A and 10B are diagrams illustrating a gain switch on a synchronous detection board in the image forming apparatus of FIG. 1, to prevent false detection of stray light;

FIGS. 11A and 11B are diagrams illustrating a gain switch on a synchronous detection board in the image forming apparatus of FIG. 1, to prevent missed detection;

FIGS. 12A and 12B are diagrams illustrating a shift in write start timing caused by a gain switch in the image forming apparatus of FIG. 1;

FIGS. 13A and 13B are diagrams illustrating the switching of gain resistance from high gain to low gain in the image forming apparatus of FIG. 1;

FIGS. 14A and 14B are diagrams illustrating the switching of gain resistance from small gain to high gain in the image forming apparatus of FIG. 1;

FIGS. 15A and 15B are diagrams illustrating the switching of gain resistance with multiple operation modes in the image forming apparatus of FIG. 1;

FIG. 16 is a flowchart of a printing process of the image forming apparatus in FIG. 1;

FIG. 17 is a flowchart of a density adjustment process of the image forming apparatus in FIG. 1;

FIG. 18 is a flowchart of a color registration process of the image forming apparatus in FIG. 1;

FIG. 19 is a diagram illustrating a configuration of a synchronous detection board in an image forming apparatus according to a second embodiment;

FIG. 20 is a diagram illustrating a shift in write start timing caused by a gain switch in the image forming apparatus of FIG. 19;

FIG. 21 is a diagram illustrating the switching of gain resistance from middle gain to low gain or high gain in the image forming apparatus of FIG. 19;

FIG. 22 is a diagram illustrating the switching of gain resistance from high gain to middle gain or low gain in the image forming apparatus of FIG. 19;

FIGS. 23A and 23B are diagrams illustrating the switching of gain resistance from high gain to middle gain or low gain in the image forming apparatus of FIG. 19, operating in multiple modes; and

FIGS. 24A and 24B are diagrams illustrating the switching of gain resistance from low gain to middle gain or high gain in the image forming apparatus of FIG. 19, operating in multiple modes.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

In an image forming apparatus, the laser beam output from the laser diode is reflected by a rotating polygon mirror. As the laser beam is scanned across a surface of the polygon mirror from one edge to the other, the laser beam is deflected according to the angle of the polygon mirror, scanning one line on the surface of the photoconductor. During this scanning, the laser diode is turned on and off according to the input image data, forming an electrostatic latent image corresponding to one scan line on the photoconductor. The image forming apparatus repeats this line-by-line scanning while rotating the photoconductor, forming an electrostatic latent image corresponding to a desired image. In this case, the image forming apparatus needs to align the write start timing each time line scanning is repeated for proper image formation. To determine this timing, an optical sensor is placed just before the laser beam scans the photoconductor to detect its scanning position. The image forming apparatus determines the timing to start writing image data in accordance with the output signal from the optical sensor. The optical sensor includes a photodiode and detects small current variations by using gain. The optical sensor determines whether the laser beam is incident based on the detected current variation. Since the laser beam intensity can vary with conditions such as print resolution, productivity (linear velocity), and ambient temperature, the intensity received by the optical sensor also changes accordingly. When the variation in the intensity of the laser beam incident on the optical sensor becomes large, a single gain setting may no longer be sufficient. In addition, if the gain is set too high, stray light from unintended paths may be detected when the intensity of the laser beam incident on the optical sensor is strong. Conversely, if the gain is too low, low beam intensity at the optical sensor may cause increased jitter in the detection waveform or failure to detect the laser beam. To address this, a technique has been proposed that switches the gain of the optical sensor according to the intensity of the received laser beam.

Since the intensity of the laser beam incident on the optical sensor is affected by changes in ambient temperature or humidity, the gain is switched during the operation of the image forming apparatus. Specifically, to prevent false detection of stray light and missed detection of the laser beam, the gain is appropriately adjusted based on the laser beam intensity during operation of the image forming apparatus. Gain refers to a parameter that adjusts the sensitivity for detecting the laser beam. Higher gain increases detection sensitivity, while lower gain reduces detection sensitivity. If the detection sensitivity changes, the laser beam waveform detected by the optical sensor also changes, which may cause a shift in detection timing. This may shift the write start timing, causing a positional deviation in the main scanning direction. As a result, color tone variations and color misregistration can occur, reducing image quality—a significant concern in color printers.

To address this, color misregistration correction is typically performed as a control method after the gain is switched. This color misregistration correction also correct shifts in the write start timing caused by gain switching, enabling high-quality image formation when completed properly.

As a technique for correcting such color misregistration, a control method is disclosed that corrects color misregistration after changing the detection sensitivity, to correct shifts in the write start timing caused by changes in detection sensitivity (or gain switching).

However, such a technique involves the color misregistration correction for each gain switching when gain is frequently switched. Since the operation of image formation is stopped during the color misregistration correction and supply costs for forming color registration pattern increase, productivity may decrease.

According to one aspect of the present disclosure, the decrease in productivity can be reduced.

An image forming apparatus according to an embodiment of the present disclosure will be described in detail with reference to the drawings. The present disclosure, however, is not limited to the following embodiment, and components of the following embodiment include components that may be easily conceived by those skilled in the art, components being substantially the same, and components being within equivalent ranges. Furthermore, various omissions, substitutions, changes, and combinations of the components can be made without departing from the gist of the following embodiment.

### First Embodiment

### Configuration of Image Forming Apparatus

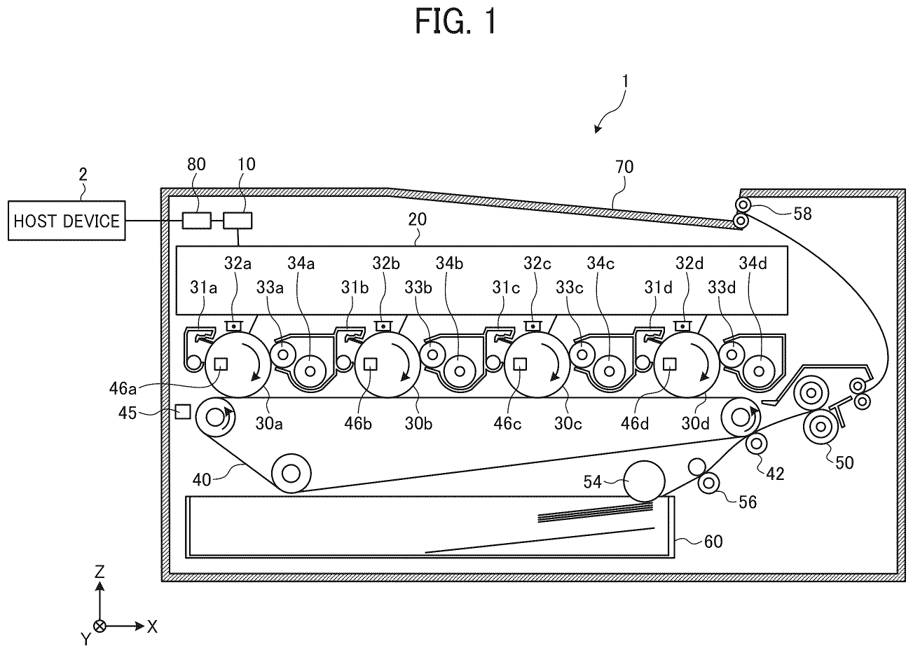

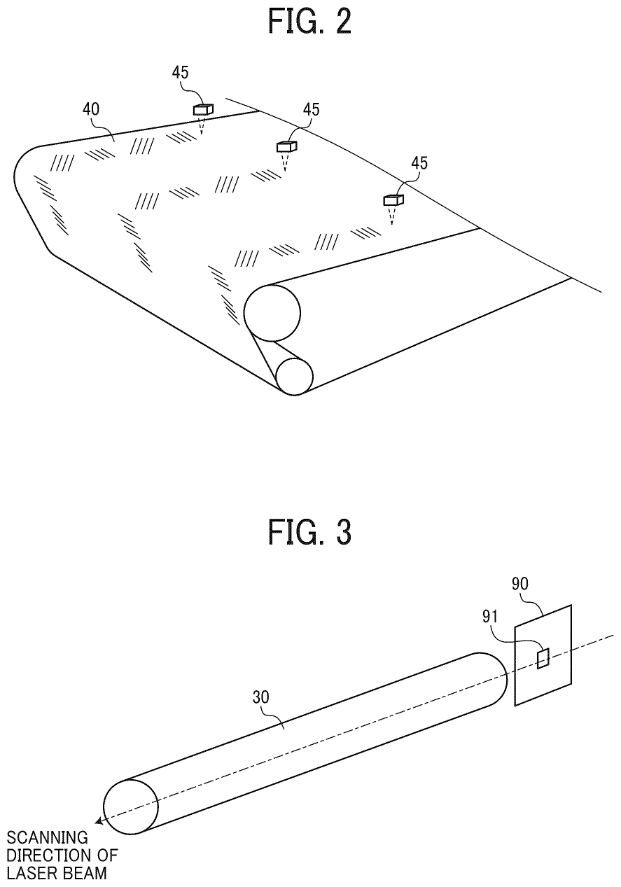

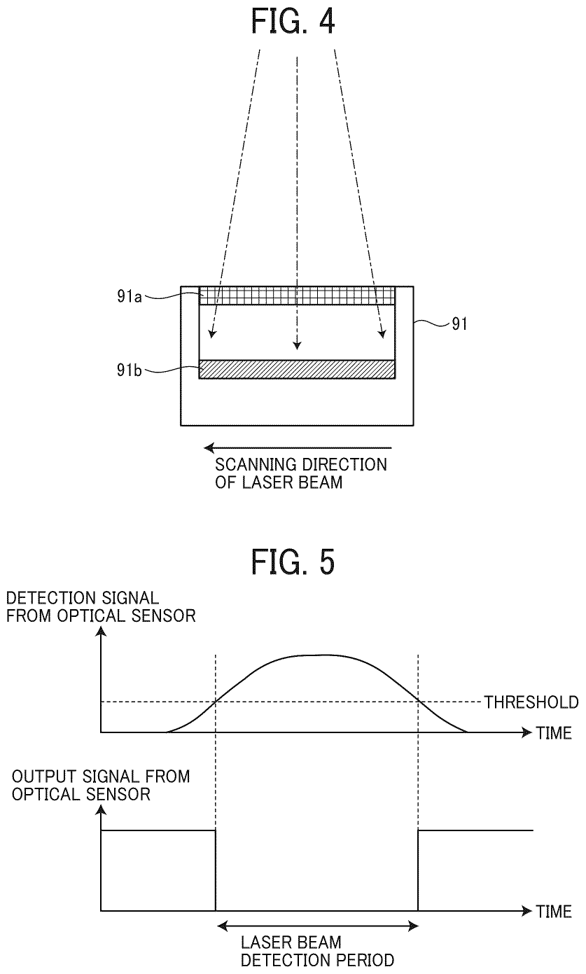

FIG. 1 is a diagram illustrating a configuration of an image forming apparatus 1 according to a first embodiment. FIG. 2 is a diagram illustrating an operation of forming a color registration pattern to correct color misregistration in the image forming apparatus 1 of FIG. 1. FIG. 3 is a diagram illustrating a scanning operation of a laser beam in the image forming apparatus 1 of FIG. 1. FIG. 4 is a diagram illustrating a laser beam entering an optical sensor 91 in the image forming apparatus 1 of FIG. 1. FIG. 5 is a diagram illustrating a detection signal and an output signal in the optical sensor 91 of the image forming apparatus 1 in FIG. 1. Referring to FIGS. 1 to 5, the configuration of the image forming apparatus 1 according to the present embodiment is described below.

The image forming apparatus 1 illustrated in FIG. 1 transfers toner onto a recording sheet and forms a printed material. For example, the image forming apparatus 1 uses a tandem configuration to form full-color images by superimposing four colors: cyan, magenta, yellow, and black.

As illustrated in FIG. 1, the image forming device 1 includes a controller 10, an optical scanner 20, four photoconductor drums 30a, 30b, 30c, and 30d, four cleaning units 31a, 31b, 31c, and 31d, four chargers 32a, 32b, 32c, and 32d, four developing rollers 33a, 33b, 33c, and 33d, and four toner cartridges 34a, 34b, 34c, and 34d. As illustrated in FIG. 1, the image forming device 1 further includes a transfer belt 40, a transfer roller 42, a density sensor 45, four home position sensors 46a, 46b, 46c, and 46d, a fixing roller 50, a sheet feeding roller 54, a registration roller pair 56, a sheet ejection roller 58, a sheet tray 60, an output tray 70, and a communication controller 80.

The photoconductor drum 30a, the cleaning unit 31a, the charger 32a, the developing roller 33a, and the toner cartridge 34a are used as a set. These components form an image forming station for forming black (K) images, also referred to as a K station.

The photoconductor drum 30b, the cleaning unit 31b, the charger 32b, the developing roller 33b, and the toner cartridge 34b are used as a set. These components form an image forming station for forming cyan (C) images, also referred to as a C station.

The photoconductor drum 30c, the cleaning unit 31c, the charger 32c, the developing roller 33c, and the toner cartridge 34c are used as a set. These components form an image forming station for forming magenta (M) images, also referred to as a M station.

The photoconductor drum 30d, the cleaning unit 31d, the charger 32d, the developing roller 33d, and the toner cartridge 34d are used as a set. These components form an image forming station for forming yellow (Y) images, also referred to as a Y station.

Any of the photoconductor drums 30a to 30d may be referred to individually or collectively as “the photoconductor drum 30”. Any of the cleaning units 31a to 31d may be referred to individually or collectively as “the cleaning unit 31”. Any of the chargers 32a to 32d may be referred to individually or collectively as “the charger 32”. Any of the developing rollers 33a to 33d may be referred to individually or collectively as “the developing roller 33”. Any of the toner cartridges 34a to 34d may be referred to individually or collectively as “the toner cartridge 34”. Any of the home position sensors 46a to 46d may be referred to individually or collectively as “the home position sensor 46”.

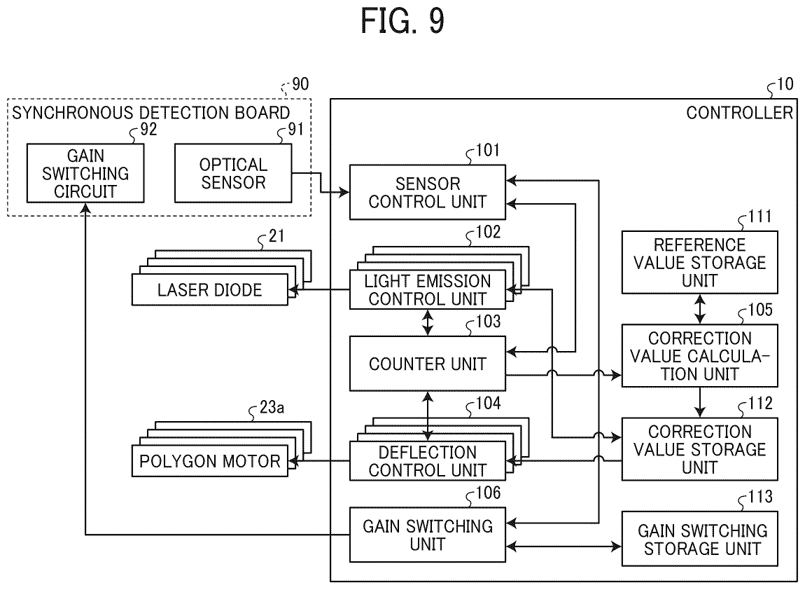

The controller 10 comprehensively controls each component of the image forming apparatus 1. The controller 10 includes, a central processing unit (CPU), a read only memory (ROM), a random access memory (RAM), and an analog-to-digital (A/D) converter. The ROM stores programs described in codes that can be executed by the CPU and various data used during program execution. The RAM is a working memory. The A/D converter converts analog data to digital data. Additionally, the controller 10 controls the respective components in response to requests from a host device 2 and sends image data from the host device 2 to the optical writing unit 20. The host device 2 is an information processing apparatus such as a personal computer (PC) or a workstation that sends a print job including image data to be printed to the controller 10 via the communication controller 80. Details of the configuration and operation of the controller 10 is described later with reference to FIG. 9.

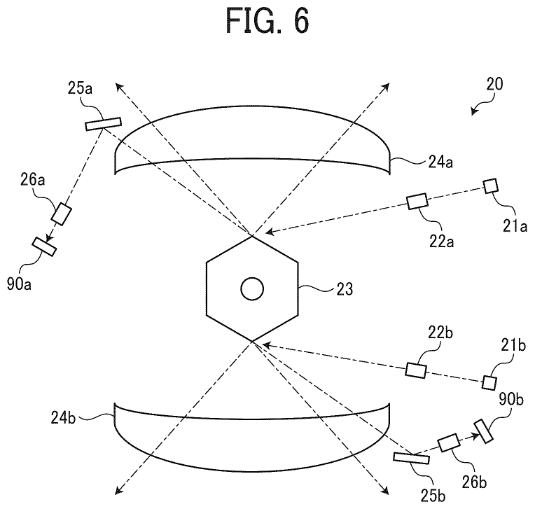

The optical scanner 20 irradiates the charged surfaces of the photoconductor drums 30a, 30b, 30c, and 30d (or photoconductors) with laser beams modulated based on cyan, magenta, yellow, and black image data. This irradiation removes the charge from the exposed areas on the surfaces of the photoconductor drums 30a, 30b, 30c, and 30d, forming latent images corresponding to the image data the surfaces. As each photoconductor drum 30 rotates, the latent image formed on its surface moves toward the corresponding developing roller 33. The configuration of the optical scanner 20 is described in detail later with reference to FIG. 6.

Each photoconductor drum 30 is an example of a latent image carrier, and is a drum-shaped member having a photosensitive layer formed on its surface. The optical scanner 20 scans the surfaces of the photoconductor drums 30a, 30b, 30c, and 30d with laser beams. The photoconductor drums 30a, 30b, 30c, and 30d are arranged side by side with their rotation axes parallel to each other and rotate in the same direction (e.g., the direction of the arrow in FIG. 1).

In three-dimensional orthogonal coordinates XYZ as illustrated in FIG. 1, the X-axis indicates the direction in which the four photoconductor drums 30a, 30b, 30c, and 30d are aligned, and the Y-axis is parallel to the axial direction of each drum.

The cleaning unit 31 removes residual toner from the surface of the photoconductor drum 30. As each photoconductor drum 30 rotates, its cleaned surface returns to the position facing the corresponding charger 32.

The charger 32 uniformly charges the surface of its corresponding photoconductor drum 30.

As the development rollers 33a, 33b, 33c, and 33d rotate, their surfaces are evenly coated with a thin layer of toner supplied from the respective toner cartridges 34a, 34b, 34c, and 34d. When the toner on the surface of each developing roller 33 contacts the surface of the corresponding photoconductor drum 30, the toner transfers and adheres to the exposed area on the surface of the photoconductor drum 30. In short, the development rollers 33a, 33b, 33c, and 33d develop the latent images formed on the surfaces of the corresponding photoconductive drums 30a, 30b, 30c, and 30d with toner into visible toner images.

The toner cartridge 34a supplies black toner to the developing roller 33a. The toner cartridge 34b supplies cyan toner to the developing roller 33b. The toner cartridge 34c supplies magenta toner to the developing roller 33c. The toner cartridge 34d supplies yellow toner to the developing roller 33d.

The transfer belt 40 is entrained around a belt rotation mechanism, to rotate in a given direction. The outer surface of the transfer belt 40 contacts the surface of each photoconductor drum 30 opposite the optical scanner 20, and toner images are successively overlaid to create a color image. The transfer roller 42 also contacts the outer circumferential surface of the transfer belt 40.

The transfer roller 42 contacts the outer surface of the transfer belt 40 via the recording sheet and transfers the color toner image from the transfer belt 40 onto the sheet.

The density sensor 45 is a toner monitor (TM) sensor positioned on the—X side, downstream of the four photoconductor drums 30a, 30b, 30c, and 30d, facing the transfer belt 40, and detects the toner density of color toner images on the transfer belt 40. As illustrated in FIG. 2, multiple density sensors 45 are arranged in the main scanning direction, which is perpendicular to the moving direction of the transfer belt 40. During color registration, the image forming apparatus 1 forms a color registration pattern that passes the detection positions of the respective density sensors 45, allowing each sensor to detect the color registration pattern. The image forming apparatus 1 then calculates correction values to adjust color misregistration and magnification errors, based on the detection results from the density sensors 45. The correction value for the write start timing is included as one of these correction values.

The home position sensor 46 detects the home position (or initial position) of the corresponding photoconductor drum 30.

The fixing roller 50 applies heat and pressure to the recording sheet to fix the toner on the recording sheet. Then, the recording sheet is conveyed onto the output tray 70 via the sheet ejection roller 58. Thus, the recording sheets are sequentially stacked on the output tray 70.

The sheet feeding roller 54 is disposed near the sheet tray 60, and feeds recording sheets one by one from the sheet tray 60 to the registration roller pair 56.

The registration roller pair 56 feeds the recording sheet toward the gap between the transfer belt 40 and the transfer roller 42 at a predetermined timing, which is referred to as a secondary transfer nip. Accordingly, a color toner image is transferred onto the recording sheet from the transfer belt 40 at a secondary transfer nip. The recording sheet is then conveyed from the transfer belt 40 to the fixing roller 50.

The sheet ejection roller 58 ejects the recording sheet, on which the color toner image has been transferred and fixed, into the output tray 70.

The sheet tray 60 stores one or more recording sheets. The output tray 70 stacks recording sheets onto which color toner images have been transferred and which have been ejected by the sheet ejection roller 58.

The communication controller 80 controls bidirectional communication with a host device 2 (e.g., a computer) via a network. The communication controller 80 implements communication in accordance with standards such as Transmission Control Protocol (TCP)/Internet Protocol (IP) or Universal Serial Bus (USB).

As illustrated in FIG. 3, the image forming apparatus 1 includes a synchronous detection board 90 mounting an optical sensor 91 (or a photosensor) that detects a laser beam scanning a corresponding photoconductor drum 30 from the optical scanner 20. That is, the image forming apparatus 1 includes synchronous detection boards for the respective photoconductor drums 30a, 30b, 30c, and 30d. In FIG. 3, for simplicity, the synchronous detection board 90 is illustrated as being disposed along an extension of the axis of the photoconductor drum 30. The actual arrangement of the synchronous detection boards 90 are described later with reference to FIG. 6. The optical sensor 91 mounted on the synchronous detection board 90 is disposed on the scanning line of a laser beam from the optical scanner 20.

The optical sensor 91 detects the laser beam immediately before or after a single scan across the photoconductor drum 30 by the optical scanner 20, and outputs a synchronization signal. The optical sensor 91 is configured by a semiconductor element, such as a photodiode, that generates a current when exposed to light. As illustrated in FIG. 4, the optical sensor 91 includes a lens 91a, a light receiver 91b, and a comparator. The optical sensor 91 further includes a slit that reduces disturbance light and narrows or restricts the incident direction of incoming light to enhance detection accuracy.

The lens 91a is an optical component that restricts the direction of incoming light. The light receiver 91b generates a current upon receiving a laser beam, and a built-in operational amplifier circuit amplifies the current.

The amplified current flows through a variable gain resistor, which will be described later, and is output as the detection signal of the optical sensor 91. The comparator compares the detection signal, which is an analog value, with a predetermined constant voltage (e.g., a threshold illustrated in FIG. 5), and converts the detection signal into a digital output signal (or a synchronization signal). This digital signal represents a period during which the detection signal exceeds the constant voltage, indicating a laser beam detection period. In FIG. 5, the output signal (or a synchronization signal) remains at a low level during the period when the detection signal exceeds the constant voltage (i.e., threshold), and at a high level when the detection signal does not exceed the threshold.

The optical sensor 91 outputs a digital output signal (or a synchronization signal) to the controller 10. The controller 10 determines the timing to start writing the laser beam onto the photoconductor drum 30 with the optical scanner 20, based on the synchronization signal output from the optical sensor 91.

### Configuration of Optical Scanner

FIG. 6 is a diagram illustrating a configuration of an optical scanner in the image forming apparatus according to the first embodiment. Referring to FIG. 6, the configuration of the optical scanner 20 in the image forming apparatus 1 according to the present embodiment is described below.

As illustrated in FIG. 6, the optical scanner 20 includes laser diodes 21a and 21b, lenses 22a and 22b, a polygon mirror 23 (or a deflector), f-θ lenses 24a and 24b, mirrors 25a and 25b, and lenses 26a and 26b. The optical scanner 20 further includes a polygon motor 23a as illustrated in FIG. 9.

The laser diodes 21a and 21b emit laser beams. The laser diodes 21a and 21b are controlled by a light emission control unit 102 described later to turn the laser beam on and off and control its intensity. The laser beams emitted from the laser diodes 21a and 21b reach the photoconductor drums 30 30 through optical systems described later.

The lenses 22a and 22b respectively collimate the laser beams emitted from the laser diodes 21a and 21b by refraction.

The polygon mirror 23 is rotated by a polygon motor 23a, which will be described later, and has the shape of a polygonal column when viewed along its rotation axis. The polygon mirror 23 rotates at a predetermined rotation speed and reflects (or deflects) the laser beams, which have passed through the lenses 22a and 22b, toward the f-θ lenses 24a and 24b, thus repeatedly scanning the laser beams in the main scanning direction, which extends along the axis of the photoconductor drum 30. The laser beam scanned in the main scanning direction by the rotation of the polygon mirror 23 is reflected by the mirrors 25a and 25b before or after scanning the photoconductor drum 30, and then enters the synchronous detection boards 90a and 90b.

The f-θ lenses 24a and 24b convert the laser beams, reflected and scanned at a constant angular speed by the polygon mirror 23, into linear scans on the photoconductor drums 30 at a constant speed. The polygon mirror 23 and f-θ lenses 24a and 24b repetitively scan laser beams in the main scanning direction on the photoconductor drums 30, forming electrostatic latent images (or latent images) based on the image data on the photoconductor drums 30. Since the width of the electrostatic latent image corresponds to the image width, the area outside this width on the photoconductor drum 30 is considered outside the image region.

The mirrors 25a and 25b reflect the laser beams, which are scanned in the main scanning direction by the rotating polygon mirror 23, toward the lenses 26a and 26b, before or after the laser beams are scanned onto the photoconductor drums 30.

The lenses 26a and 26b transmit the laser beams reflected from the mirrors 25a and 25b into the synchronous detection boards 90a and 90b, respectively.

The synchronous detection boards 90a and 90b, which correspond to the synchronous detection board 90 described above, are positioned outside the image region in the main scanning direction on the surfaces of the respective photoconductor drums 30, and are each located near the start point or end point of the laser beam scanning line in the main scanning direction. Each of the synchronous detection boards 90a and 90b has a optical sensor 91 that detects the laser beam and outputs a synchronous signal to the controller 10.

As described above, the laser beams emitted from the laser diodes 21a and 21b pass through the lenses 22a and 22b, the polygon mirror 23, the f-θ lenses 24a and 24b in that order, reaching the photoconductor drums 30 to form electrostatic latent images of the respective colors on the photoconductor drums 30.

The configuration of the optical scanner 20 illustrated in FIG. 6 is merely an example, and alternative optical systems may be employed. For example, the optical scanner 20 may include an additional set of the units as illustrated in FIG. 6 to form electrostatic latent images of respective colors on the four photoconductor drums 30. In this case, the image forming apparatus 1 includes four synchronous detection boards 90 with optical sensors 91 that detect laser beams and output synchronization signals for different colors to the controller 10.

### Configuration and Operation of Synchronous Detection Board

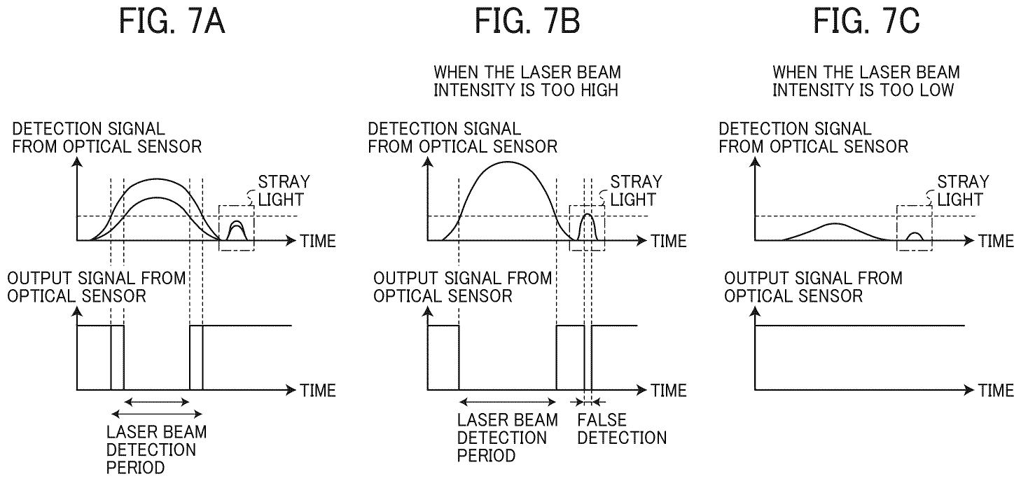

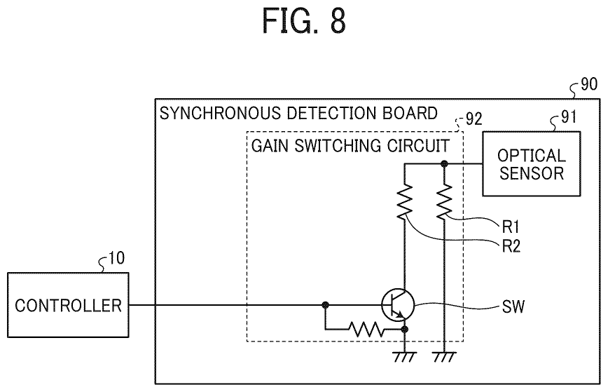

FIGS. 7A, 7B, and 7C are diagrams illustrating the relation between the intensity of a laser beam incident on an optical sensor and its detection and output signals in the image forming apparatus according to the first embodiment. FIG. 8 is a diagram illustrating a configuration of a synchronous detection board in the image forming apparatus according to the first embodiment. Referring to FIGS. 7A, 7B, 7C, and 8, the configuration of the synchronous detection board 90 in the image forming apparatus 1 according to the present embodiment is described below.

As the intensity of the laser beam incident on the optical sensor 91 changes, the corresponding detection signal also changes. As illustrated in FIG. 7A, an analog detection signal increases with increasing laser beam intensity and decreases as the laser beam intensity decreases. This results in an extended or shortened detection period of the low-level output signal from the optical sensor 91. The image forming apparatus I uses the rising or falling edge of the output signal (or the synchronization signal) as the detection point of the laser beam incident on the optical sensor 91. In this configuration, the edge position may vary with the laser beam intensity, causing a shift in the write start timing.

FIG. 7B presents a case of increased laser beam intensity incident at the optical sensor 91. When the intensity of the laser beam incident on the optical sensor 91 is too high, stray light may cause the laser beam to be detected at an incorrect timing, resulting in a malfunction.

FIG. 7C presents a case of reduced intensity of the laser beam incident on the optical sensor 91. When the intensity of the laser beam incident on the optical sensor 91 is too low, the analog detection signal does not reach the constant voltage (or the threshold) of the comparator, resulting a detection failure and causing a malfunction.

As illustrated in FIGS. 7B and 7C, when the laser beam intensity incident at the optical sensor 91 is too high or too low, stray light may cause a false detection or missed detection of the laser beam. To avoid such a situation, the synchronous detection board 90 of the image forming apparatus 1 is configured to switch the gain of the optical sensor 91 as illustrated in FIG. 8.

As illustrated in FIG. 8, the synchronous detection board 90 includes an optical sensor 91 and a gain switching circuit 92 as an example of a sensitivity switching circuit. The gain switching circuit 92 switches gain to adjust the detection sensitivity of the optical sensor 91 according to a gain switching signal input from the controller 10. The gain switching circuit 92 includes a resistor R1, a resistor R2, and a switching device SW.

In the synchronous detection board 90, the gain resistance of the optical sensor 91 is switched in response to a gain switching signal input from the controller 10. The gain switching signal is applied to the base of the switching device SW. In the synchronous detection board 90 illustrated in FIG. 8, when the gain switching signal input from the controller 10 is at a low voltage level, the gain resistance is set to the value of the resistor R1. When the gain switching signal input from the controller 10 is at a high voltage level, the gain resistance is set to the combined resistance of the resistor R1 and the resistor R2 connected in parallel, which is calculated as 1/(1/R1+1/R2).

In FIG. 8, the gain switching circuit 92 is configured as an external circuit relative to the optical sensor 91, but is not limited to this configuration. This circuit may instead be built into the optical sensor 91. In the following description, the gain switching circuit 92 is described as a circuit externally attached to the optical sensor 91.

### Configuration and Operation of Functional Block of Controller

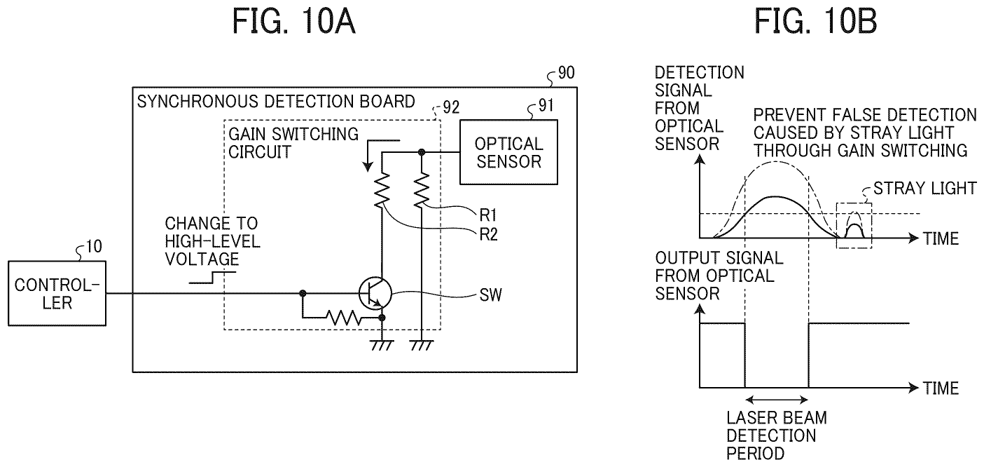

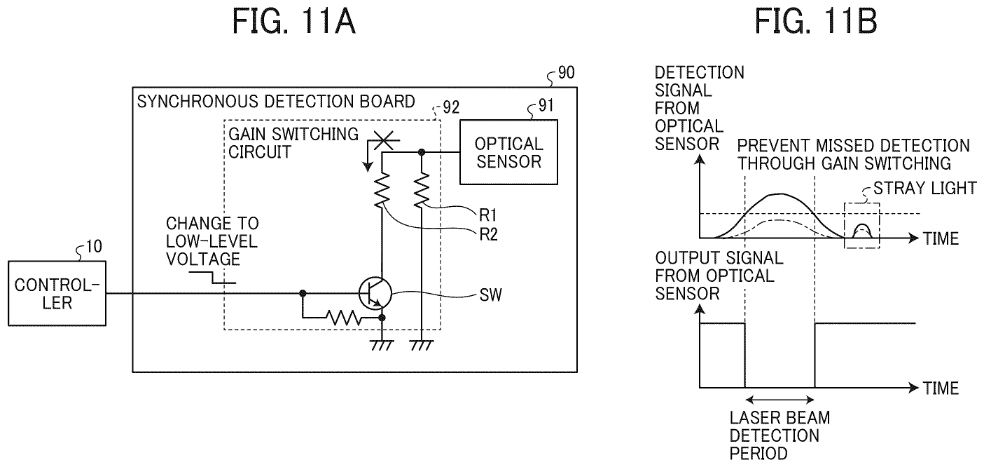

FIG. 9 is a block diagram of a functional configuration of a controller in the image forming apparatus according to the first embodiment. FIGS. 10A and 10B are diagrams illustrating a gain switch on a synchronous detection board in the image forming apparatus according to the first embodiment, to prevent false detection of stray light. FIGS. 11A and 11B are diagrams illustrating a gain switch on a synchronous detection board in the image forming apparatus according to the first embodiment, to prevent missed detection. Referring to FIGS. 9 to 11A and 11B, the functional configuration of the controller 10 in the image forming apparatus 1 according to the present embodiment is described below.

As illustrated in FIG. 9, the controller 10 includes functional units such as a sensor control unit 101, a light emission control unit 102, a counter unit 103, a deflection control unit 104, a correction value calculation unit 105, a gain switching unit 106 (or sensitivity switching unit), a reference value storage unit 111, a correction value storage unit 112, and a gain switching storage unit 113.

The sensor control unit 101 controls the operation of the optical sensor 91. The sensor control unit 101 receives a synchronization signal output from the optical sensor 91 upon detecting a laser beam.

The light emission control unit 102 controls the turning on and off of the laser diode 21 (light-emitting clement or a light emitter) and adjusts the intensity of the laser beam emitted from the laser diode 21. Specifically, the light emission control unit 102 transfers a turn-on signal and a turn-off signal according to the image data to the laser diode 21, based on a count-up signal from the counter unit 103 that counts according to the synchronization signal output from the sensor control unit 101, in order to form an electrostatic latent image on the photoconductor drum 30. Accordingly, the start of transferring the turn-on and turn-off signals is referred to as the write start timing. A technique has been proposed that varies the laser beam intensity at a specific scanning timing. However, in the present embodiment, a constant-intensity laser beam is assumed to be emitted throughout the entire laser-beam scanning period to reduce manufacturing costs.

The counter unit 103 automatically increments its internal count value when the synchronization signal is received by the sensor control unit 101 from the optical sensor 91. Specifically, the counter unit 103 resets the internal count value when the sensor control unit 101 starts receiving the synchronization signal. Then, the counter unit 103 outputs a signal to the light emission control unit 102 when the incremented internal count value reaches a predetermined value. The predetermined value is defined as the sum of a reference value determined based on the arrangement of the photoconductor drums 30 and the arrangement of the optical sensors 91, and a correction value for color misregistration in the main scanning direction for each color. The correction value for color misregistration in the main scanning direction is stored in the correction value storage unit 112. The light emission control unit 102 reads the correction value from the correction value storage unit 112 before the start of the image formation by laser emission from the laser diode 21.

The deflection control unit 104 controls the rotation of the polygon motor 23a, and causes the laser beam emitted from the laser diode 21 to scan the photoconductor drum 30 in the main scanning direction.

The correction value calculation unit 105 calculates a correction value for color misregistration. The correction value calculation unit 105 updates the correction value stored in the correction value storage unit 112 with the calculated correction value. In this configuration, the color misregistration correction through color registration enables a high-quality latent image to be formed at the intended position on the photoconductor drum 30.

The gain switching unit 106 switches the gain by outputting a gain switching signal to the gain switching circuit 92 on the synchronous detection board 90. The gain switching unit 106 stores gain information, such as a gain resistor value or a gain switching signal level, in the gain switching storage unit 113 when the gain is switched.

The reference value storage unit 111 stores the reference value described above. The reference value storage unit 111 is implemented, for example, by the above-described ROM.

The correction value storage unit 112 stores the correction value calculated by the correction value calculation unit 105. The correction value storage unit 112 is implemented, for example, by the above-described RAM.

The gain switching storage unit 113 stores gain information switched by the gain switching unit 106. The gain switching storage unit 113 is implemented, for example, by the above-described RAM.

The sensor control unit 101, the light emission control unit 102, the counter unit 103, the deflection control unit 104, the correction value calculation unit 105, and the gain switching unit 106 described above are implemented by the CPU executing a program. At least some of the sensor control unit 101, the light emission control unit 102, the counter unit 103, the deflection control unit 104, the correction value calculation unit 105, and the gain switching unit 106 may be implemented by a hardware circuit such as a field-programmable gate array (FPGA) or an application specific integrated circuit (ASIC).

Each functional unit of the controller 10 illustrated in FIG. 9 conceptually indicates a function, and is not limited to such a configuration. That is, the functional units of the controller 10 do not have to be implemented by software modules distinct as the blocks illustrated in FIG. 9. The functions of the functional units as a whole may be implemented by the controller 10 executing a program. For example, multiple functional units illustrated as independent functional units in the controller 10 illustrated in FIG. 9 may serve as one functional unit. In contrast, the function of one functional unit in the controller 10 illustrated in FIG. 9 may be divided into multiple functions to serve as multiple functional units.

In the present embodiment, it is assumed that false detection of stray light occurs due to the excessively high laser-beam intensity on the optical sensor 91, as illustrated in FIG. 7B. In this case, it is assumed that the gain switching signal output from the gain switching unit 106 is at a low level, and the gain resistance is set to the value of resistor R1, which is referred to as high gain or first sensitivity in the present embodiment. With this gain switching signal, the detection sensitivity for the laser beam is high, sometimes referred to simply as high gain. The waveform of the detection signal is indicated by the one-dot chain line in FIG. 10B. False detection of stray light occurs when the waveform of the detection signal exceeds the constant voltage (or threshold) of the comparator. In this case, reducing the voltage of the analog detection signal waveform can prevent false detection of stray light.

As illustrated in FIG. 10A, the gain switching unit 106 switches the gain switching signal to high level to switch the gain resistance to a value of 1/(1/R1+1/R2), referred to as a low gain or second sensitivity in the present embodiment, which is lower than the high gain (i.e., the value of the resistor R1), thus lowering the detection sensitivity of the laser beam. The lowered detection sensitivity is referred to as a low gain. This results in a detection signal waveform smaller than that in the high gain, as illustrated in FIG. 10B, thus preventing false detection caused by stray light.

In the present embodiment, it is also assumed that missed detection may occur due to the excessively low laser-beam intensity on the optical sensor 91, as illustrated in FIG. 7C. In this case, it is assumed that the gain switching signal output from the gain switching unit 106 is at a high level, and the gain resistance is set to the value of 1/(1/R1+1/R2), which is referred to as low gain. This results in a lower detection sensitivity for the laser beam. The waveform of the detection signal under this condition is indicated by the one-dot chain line in FIG. 11B. Missed detection occurs when the waveform of the detection signal does not reach the constant voltage (or threshold) of the comparator. In this case, increasing the voltage of the analog detection signal waveform can prevent missed detection of stray light.

As illustrated in FIG. 11A, the gain switching unit 106 switches the gain switching signal to low level to switch the gain resistance to a value of the resistor R1, referred to as a high gain, which is higher than the low gain (i.e., the value of the resistor R1), thus increasing the detection sensitivity of the laser beam. This results in a detection signal waveform larger than that in the low gain, as illustrated in FIG. 11B, thus preventing missed detection.

### Operation in Case of Switching Gain of Optical Sensor

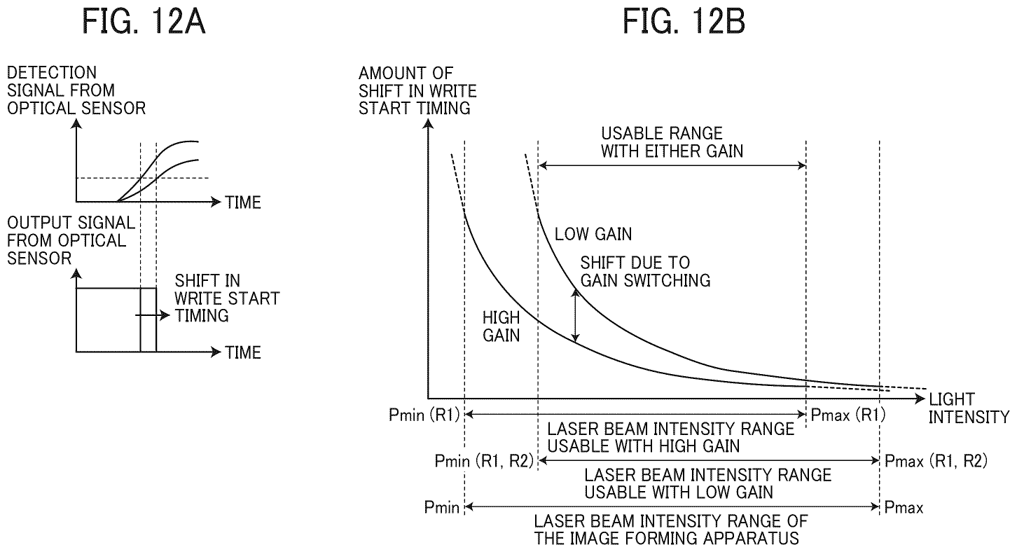

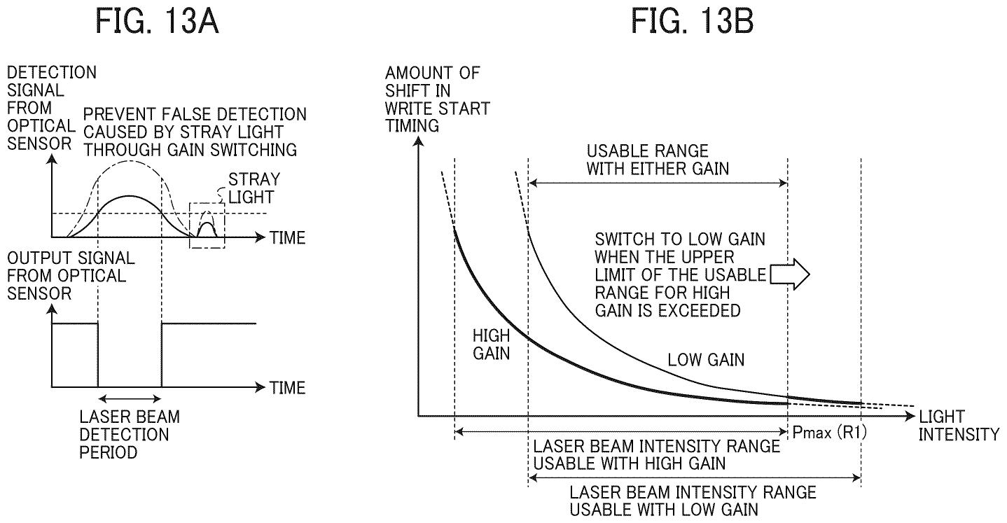

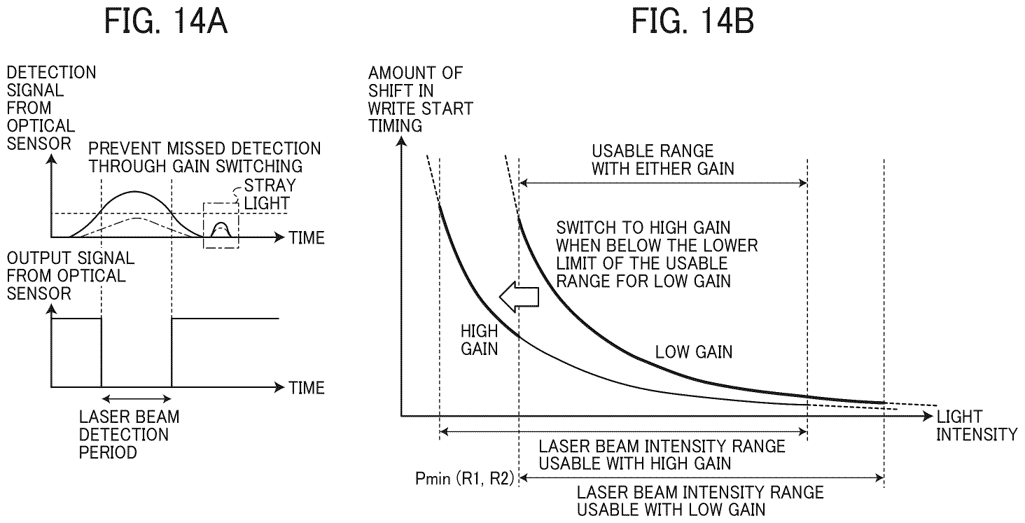

FIGS. 12A and 12B are diagrams illustrating a shift in write start timing caused by a gain switch in the image forming apparatus according to the first embodiment. FIGS. 13A and 13B are diagrams illustrating the switching of gain resistance from high gain to low gain in the image forming apparatus according to the first embodiment. FIGS. 14A and 14B are diagrams illustrating the switching of gain resistance from small gain to high gain in the image forming apparatus according to the first embodiment. Referring to FIGS. 12A, 12B to 14A, 14B, the gain switching of the optical sensor 91 on the synchronous detection board 90, controlled by the controller 10 of the image forming apparatus 1, is described.

As illustrated FIG. 12A, the position of the rising edge or a falling edge may vary depending on the intensity of the laser beam incident on the optical sensor 91, resulting in a shift in the write start timing. FIG. 12B is a graph illustrating the amount of shift in the write start timing between the high-gain and low-gain settings in the optical sensor 91. As illustrated in FIG. 12B, the intensity of the laser beam and the amount of shift in the write start timing have a non-linear relationship. The shift increases as the laser beam intensity decreases. When the gain of the optical sensor 91 is high, the allowable range of laser beam intensity usable with high gain shifts toward lower intensities. When the gain of the optical sensor 91 is low, the allowable range of laser beam intensity usable with low gain shifts toward higher intensities. The double-headed arrow in FIG. 12B indicates the shift in write start timing caused by gain switching. Even if color misregistration correction is performed before gain switching, the writing start timing shifts when the gain is switched, resulting in image quality degradation. To address this, color misregistration correction is typically performed with the switched gain after the gain is switched. Controlling in this manner prevents the shift caused by gain switching through the color misregistration correction, thus enabling high-quality image formation. However, if gain switching is performed frequently, color misregistration correction is executed each time, resulting in reduced productivity. In view of this, the present embodiment provides a configuration that reduces the frequency of gain switching.

The positional relationship between the two curves illustrated in FIG. 12B is determined by the relationship between the resistance values of the resistor R1 and the resistor R2 in the gain switching circuit 92 illustrated in FIG. 8. As the resistance value of the resistor R2 increases, the low-gain curve approaches the high-gain curve. As the resistance value of the resistor R2 decreases, the low-gain curve moves away from the high-gain curve. The shape of each graph also changes depending on the resistance values set for the resistor R1 and the resistor R2. In the operation of the image forming apparatus 1, the laser beam intensity range at the optical sensor 91 is defined. When a single gain is not usable across the entire laser beam intensity range, switching to another gain allows the full range to be covered. The resistance values of the resistor R1 and the resistor R2 are determined to prevent false detection caused by stray light and missed detection across the entire intensity range of the laser beam incident on the optical sensor 91.

In the operation of the image forming apparatus 1, the minimum and maximum intensities of the laser beam incident on the optical sensor 91 are defined as Pₘᵢₙ and Pₘₐₓ, respectively. Pₘᵢₙ(R1) and Pₘₐₓ(R1) denote the minimum and maximum detectable laser beam intensities when the gain resistance is set to the value of the resistor R1 (high gain). The minimum and maximum values of the resistor R1 are defined as R1ₘᵢₙ and R1ₘₐₓ, respectively, and the minimum and maximum values of the resistor R2 are defined as R2ₘᵢₙ and R2ₘₐₓ, respectively. In this case, the following Equations (1) and (2) hold.

The MIN function in equation (1) returns the smaller value of its arguments.

Pmin(R1)/MIN(Pmax, Pmax (R1))×R1max≤1/(1/R1max+1/R2min) . . . (1)

1/(1/R1min+1/R2max)≤Pmax (R1)/Pmax×R1min . . . (2)

By transforming equations (1) and (2), the following equations (3) and (4) are obtained.

(Pₘᵢₙ(R1)/(MIN (Pₘₐₓ, Pₘₐₓ(R1))−Pₘᵢₙ(R1))×R1ₘₐₓ≤R2ₘᵢₙ . . . (3)

R2ₘₐₓ≤(Pₘₐₓ(R1)/(Pₘₐₓ−Pₘₐₓ(R1))×R1ₘᵢₙ . . . (4)

In this case, setting the value of the resistor R2 within the range from R2ₘᵢₙ to R2ₘₐₓ given by Equations (3) and (4) allows the resistor R2 to be used across the entire laser beam intensity range of the image forming apparatus 1.

It is also preferable to select the value of the resistor R2 as close as possible to the maximum value R2ₘₐₓ. That is, the two types of gain should be set closer together. Bringing the value of the resistor R2 closer to R2ₘₐₓ reduces the shift between the high-gain curve and the low-gain curve and minimizes the shift in the writing start timing caused by gain switching. Further, the usable laser beam intensity range for each gain becomes wider, reducing the frequency of gain switching and the frequency of color misregistration correction associated with gain switching.

Further transforming Equation (4) gives Equation (5) below. Since Equation (4) is used to determine the value of resistor R2, the inequality is replaced with an equation. In addition, since Pₘₐₓ(R1) represents the threshold intensity for high gain, the right-hand side expression indicates its involvement in determining the threshold.

Pₘₐₓ(R1)=(R2ₘₐₓ/(R1ₘᵢₙ+R2ₘₐₓ))×Pₘₐₓ . . . (5)

The combined resistance of the resistor R1 and the resistor R2 is given by 1/(1/R1+1/R2)=R1×R2/(R1+R2). Further transforming the right-hand side of Equation (5) gives Equation (6) below. When the value of the resistor R2 approaches R2ₘₐₓ, Pₘₐₓ(R1) approaches a value obtained by multiplying Pₘₐₓ by the combined resistance and dividing by the value of the resistor R1, as indicated in Equation (6).

Pₘₐₓ(R1)=(1/(1/R1ₘᵢₙ+1/R2ₘₐₓ))/R1ₘᵢₙ×Pₘₐₓ . . . (6)

The initial state is set with the optical sensor 91 operating at high gain, with the gain resistance set to the value of resistor R1. As illustrated in FIG. 13A, if the laser beam intensity on the optical sensor 91 is too high, stray light causes false detection. To prevent false detection caused by stray light, whether the laser beam intensity exceeds Pₘₐₓ(R1), which is the maximum usable laser beam intensity, is used as a determination criterion. In the operation of the image forming apparatus 1, when the intensity of the laser beam emitted from the laser diode 21 is set to exceed Pₘₐₓ(R1), which is the maximum usable laser beam intensity at the optical sensor 91, the gain switching unit 106 switches the gain of the optical sensor 91 to low gain, as illustrated in FIG. 13B.

Since the write start timing shifts when the gain is switched, the controller 10 executes color misregistration correction before the next printing operation begins.

The initial state is set with the optical sensor 91 operating at low gain, with the gain resistance set to the combined resistance value of the resistor R1 and the resistor R2 connected in parallel. As illustrated in FIG. 14A, if the laser beam intensity at the optical sensor 91 is too low, missed detection of the laser beam may occur. To prevent missed detection, whether the laser beam intensity falls below the minimum usable laser beam intensity Pₘᵢₙ(R1, R2), is used as a determination criterion. In the operation of the image forming apparatus 1, when the intensity of the laser beam emitted from the laser diode 21 is set to fall below Pₘᵢₙ(R1, R2), which is the minimum usable laser beam intensity at the optical sensor 91, the gain switching unit 106 switches the gain of the optical sensor 91 to high gain, as illustrated in FIG. 14B. Since the write start timing shifts when the gain is switched, the controller 10 executes color misregistration correction before the next printing operation begins.

As illustrated in FIGS. 13A, 13B, 14A, and 14B, the gain switching unit 106 switches the gain based on the intensity of the laser beam emitted from the laser diode 21. The switching occurs when the intensity exceeds Pₘₐₓ(R1), the first light intensity, in the case of high gain, and when the intensity falls below Pₘᵢₙ(R1, R2), the second light intensity, in the case of low gain. That is, in the image forming apparatus 1 according to the present embodiment, the light intensity condition for gain switching differs depending on the gain currently used by the optical sensor 91. That is, in the image forming apparatus 1, the light intensity condition for gain switching is set separately for each gain.

The intensity of the laser beam emitted from the laser diode 21 varies according to the density adjustment of the image forming apparatus 1. In addition, even under the same conditions, variation may occur due to fluctuations in the measurement results. If the threshold for gain switching is set to a single point, the gain may switch repeatedly due to variations in adjustment results, causing color misregistration correction to be executed each time and potentially reducing productivity. To prevent this, the resistor R1 and the resistor R2 with appropriate resistance values are selected based on Equations (3) and (4), and separate light intensity thresholds are set for switching from high gain to low gain and from low gain to high gain. As illustrated in FIGS. 13A, 13B, 14A, and 14B, continuing to use the currently set gain as much as possible up to the upper and lower limits of the usable laser beam intensity range for each gain minimizes the frequency of gain switching, reduces supply costs, and prevents a decline in the productivity of the image forming apparatus 1.

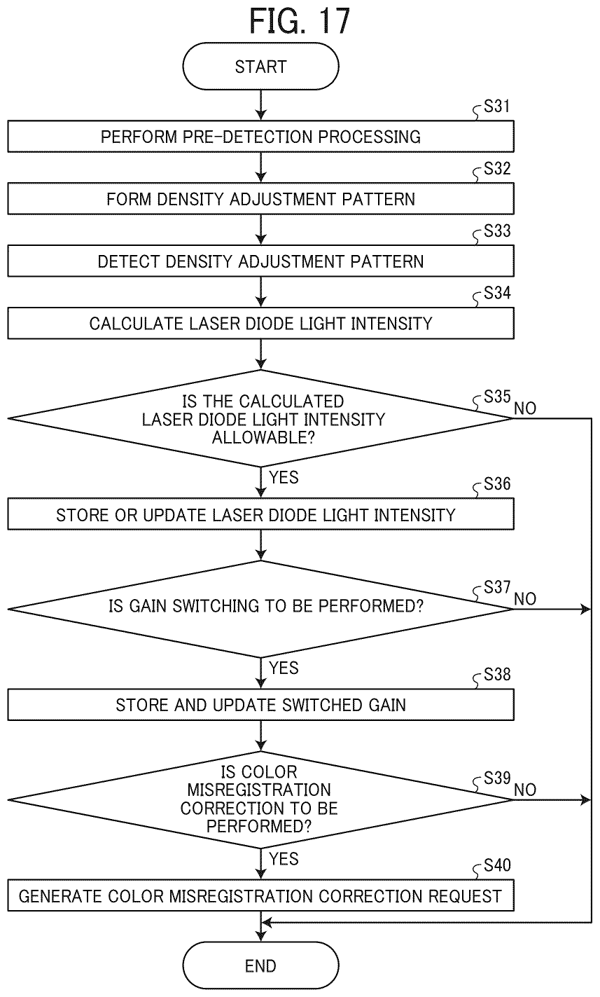

In the present embodiment, as will be described later with reference to FIG. 17, the controller 10 determines whether to execute color misregistration correction when switching the gain. Comparing the case of FIGS. 13A and 13B with FIGS. 14A and 14B demonstrates that gain switching in FIGS. 13A and 13B causes less shift in the write start timing than in FIGS. 14A and 14B. This is because, in the analog detection signal waveform from the optical sensor 91, the difference in detection timing between a waveform that slightly exceeds the comparator threshold and one that exceeds the comparator threshold greatly is smaller in the latter case. That is, when the gain switching unit 106 switches from high gain to low gain, the controller 10 may determine that the shift in write start timing is within the allowable range and may not execute the color misregistration correction. When the gain switching unit 106 switches from low gain to high gain, the controller 10 may determine that the shift in write start timing is not within the allowable range and may perform the color misregistration correction. The color misregistration correction is performed only when the controller 10 determines that the correction is to be performed. This reduces a decline in the productivity of the image forming apparatus 1.

### Gain Switching in Multiple Operation Modes

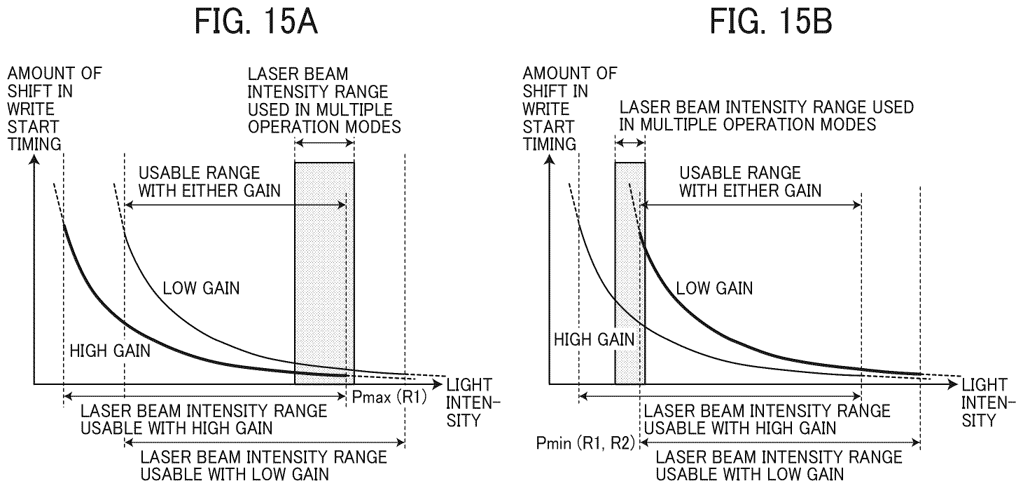

FIGS. 15A and 15B are diagrams illustrating the switching of gain resistance with multiple operation modes in the image forming apparatus according to the first embodiment. The following describes how the controller 10 of the image forming apparatus 1 switches the gain resistance in multiple operation modes.

In FIGS. 12A, 12B to 14A, and 14B, it is assumed that the image forming apparatus 1 uses a laser beam with a specific intensity. In practice, the laser beam may operate at multiple intensity levels, rather than a single fixed level, depending on factors such as the productivity (linear velocity) or the output resolution setting. In addition, the intensity of the laser beam may be switched depending on operations performed by a user or service personnel. As described above, when the intensity of the laser beam incident on the optical sensor 91 changes, gain switching and color misregistration correction may be performed each time. If color misregistration correction is performed each time the laser beam intensity is changed, this may result in decreased productivity and increased supply costs. To avoid such a situation, in the present embodiment, when the laser diode 21 is controlled to emit light by the light emission control unit 102 with different laser beam intensity settings in the multiple operation modes of the image forming apparatus 1, the resistance values of the resistor R1 and the resistor R2 in the gain switching circuit 92 are selected to enable the optical sensor 91 to operate without gain switching in all operation modes, with at least one available gain setting. When switching the gain of the optical sensor 91, the gain switching unit 106 selects a gain that eliminates the need for further switching across all operation modes. This allows mode switching without gain switching or color misregistration correction, even when different laser beam intensities are used in different operation modes of the image forming apparatus 1, thus reducing a decline in the productivity of the image forming apparatus 1.

The shaded portions in FIGS. 15A and 15B indicate the laser beam intensity ranges used in each operation mode, which are switched according to the current temperature, humidity, and other environmental conditions. The gain switching unit 106 sets a gain that allows operation without switching within the specified intensity range. FIGS. 15A and 15B describe how to determine the gain so that the optical sensor 91 operates without switching gains across all operation modes.

First, the minimum allowable intensity Pₘᵢₙ(R1, R2) of the laser beam incident on the optical sensor 91 is given by the following Equation (7).

Pₘᵢₙ(R1, R2)=Pₘᵢₙ(R1)×R1ₘₐₓ/(1/(1/R1ₘₐₓ+1/R2ₘᵢₙ))=Pₘᵢₙ(R1)×(1+R1ₘₐₓ/R2ₘᵢₙ) . . . (7)

Then, by dividing the above equation (5) by equation (7), the following equation (8) is obtained.

Pₘₐₓ(R1)/Pₘᵢₙ(R1, R2)=((1/(1/R1ₘᵢₙ+1/R2ₘₐₓ))/R1ₘᵢₙ)×((1/(1/R1ₘₐₓ+1/R2ₘᵢₙ))/R1ₘₐₓ)×(Pₘₐₓ/Pₘᵢₙ(R1)) . . . (8)

Equation (8) represents the ratio of Pₘₐₓ(R1), the threshold for switching from high gain to low gain, to Pₘᵢₙ(R1, R2), the threshold for switching from low gain to high gain. If the resistance variations of the resistor R1 and the resistor R2 are small and replaced with typical values, the relationship is given by Equation (9).

Pₘₐₓ(R1)/Pₘᵢₙ(R1, R2)=((1/(1/R1+1/R2))/R1)²×(Pₘₐₓ/Pₘᵢₙ(R1)) . . . (9)

As described above, the intensity of the laser beam emitted from the laser diode 21 in the printing operation changes according to the productivity (linear velocity) or the output resolution setting. In the multiple operation modes of the image forming apparatus 1, β is the ratio of the maximum laser beam intensity to the minimum laser beam intensity used. If the resistor R1 and the resistor R2 are selected such that the result calculated by Equation (9) exceeds β, at least one gain setting becomes selectable that allows the optical sensor 91 to operate in all operation modes without switching gain. Once the gain switching unit 106 switches to such a gain, the optical sensor 91 can continue operating without switching to another gain, thus preventing color misregistration correction and reducing a decline in the productivity of the image forming apparatus 1.

### Printing Process of Image Forming Apparatus

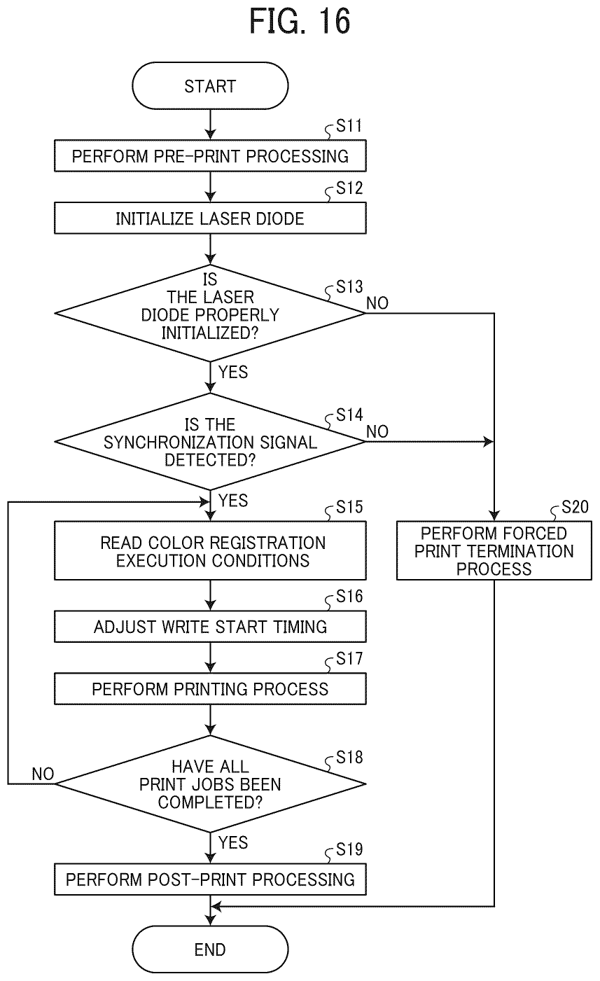

FIG. 16 is a flowchart of a printing process of the image forming apparatus in FIG. 1. Referring to FIG. 16, the printing process of the image forming apparatus 1 according to the present embodiment is described below.

### Step S11

The controller 10 of the image forming apparatus 1 performs pre-print processing, which is sometimes simply referred to as preprocessing. In the preprocessing performed by the controller 10, the gain switching unit 106 switches the gain of the optical sensor 91 based on the intensity of the laser beam emitted from the laser diode 21, which is used during the operation of the image forming apparatus 1. This switching is carried out in accordance with the methods illustrated in FIGS. 13A, 13B through 15A, and 15B. Then, the process proceeds to step S12.

### Step S12

The light emission control unit 102 of the controller 10 reads the gain information stored in the gain switching storage unit 113 and initializes the laser diode 21 using that gain. The operation then proceeds to step S13.

### Step S13

If the initialization of the laser diode 21 is successfully completed (YES in step S13), the process proceeds to step S14. If the initialization fails (NO in step S13), the process moves to step S20.

### Step S14

The sensor control unit 101 checks whether the laser beam is detected by the optical sensor 91 and whether a synchronization signal has been received from the optical sensor 91. If a synchronization signal is received (YES in Step S14), the process proceeds to step S15. If no signal is received (NO in step S14), the process moves to step S20.

### Step S15

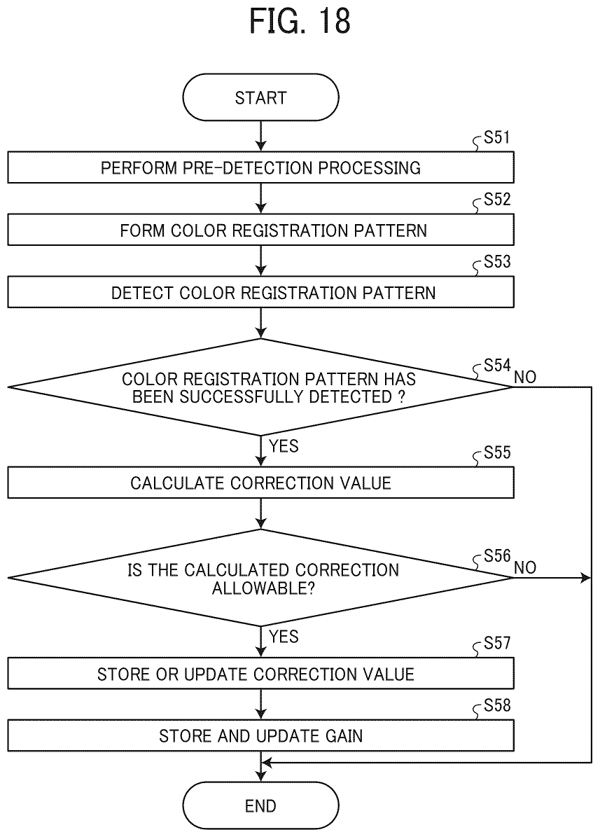

The controller 10 reads color registration execution conditions. Specifically, the controller 10 reads the gain information stored during a color registration operation to be described with reference to FIG. 18. The operation then proceeds to step S16.

### Step S16

The light emission control unit 102 adjusts the write start timing of the laser beam emitted by the laser diode 21. Then, the process proceeds to step S17.

### Step S17

The controller 10 executes a printing process. Then, the process proceeds to step S18.

### Step S18

If all print jobs have been completed (YES in step S18), the process proceeds to step S19. If not all print jobs have been completed (NO in step S18), the process returns to step S15.

### Step S19

The controller 10 executes post-printing processing. Then, the printing operation ends.

### Step S20

The controller 10 executes a forced print termination process to terminate the print operation. Then, the printing operation ends.

### Density Adjustment Processing in the Image Forming Apparatus

FIG. 17 is a flowchart of density adjustment processing of the image forming apparatus in FIG. 1. With reference to FIG. 17, the density adjustment processing of the image forming apparatus 1 according to the present embodiment is described below. When a density adjustment request is generated during the operation of the image forming apparatus 1, the following density adjustment processing is executed at a predetermined timing.

### Step S31

The controller 10 of the image forming apparatus 1 performs pre-detection processing. Then, the process proceeds to step S32.

### Step S32

The controller 10 forms a density adjustment pattern for adjusting density. Then, the process proceeds to step S33.

### Step S33

The controller 10 causes the density sensor 45 to detect the toner density of the formed density adjustment pattern. Then, the process proceeds to step S34.

### Step S34

The controller 10 calculates the intensity of the laser beam emitted by the laser diode 21. Then, the process proceeds to step S35.

### Step S35

The controller 10 determines whether the calculated intensity is allowable (or an allowable value or within an allowable range). If the light intensity is allowable (YES in step S35), the process proceeds to step S36. If the light intensity is not allowable (NO in step S35), the density adjustment processing ends.

### Step S36

The controller 10 stores the calculated light intensity of the laser diode 21 in a storage device or updates the light intensity with the calculated light intensity. Then, the process proceeds to step S37.

### Step S37

The gain switching unit 106 of the controller 10 determines whether gain switching is to be performed. Specifically, when the optical sensor 91 is operating at a high gain, the gain switching unit 106 determines whether the intensity of laser beam incident on the optical sensor 91 exceeds Pₘₐₓ(R1). When the optical sensor 91 is operating at a low gain, the gain switching unit 106 determines whether the intensity of laser beam incident on the optical sensor 91 falls below Pₘᵢₙ(R1, R2). If the intensity of laser beam exceeds the Pₘₐₓ(R1), or falls below Pₘᵢₙ(R1, R2), the controller 10 determines that gain switching is to be performed (YES in step S37), and the process proceeds to step S38. If neither conditions is met, the controller 10 determines that gain switching is not to be performed (NO in step S37), and the density adjustment processing ends.

### Step S38

The gain switching unit 106 switches the gain of the optical sensor 91. Specifically, when the optical sensor 91 is operating at a high gain, the gain switching unit 106 switches the gain of the optical sensor 91 to low gain. When the optical sensor 91 is operating with a small gain, the gain switching unit 106 switches the gain of the optical sensor 91 to high gain. Then, the gain switching unit 106 stores information on the switched gain in the gain switching storage unit 113 or updates gain information with the switched gain. Then, the process proceeds to step S39.

### Step S39

The controller 10 determines whether color misregistration correction is to be performed. For example, when the gain switching unit 106 switches from high gain to low gain, the controller 10 determines that the shift in write start timing is within the allowable range and that the color misregistration correction is not to be performed. When the gain switching unit 106 switches from low gain to high gain, the controller 10 determines that the shift in write start timing is not within the allowable range and that the color misregistration correction is to be performed. This minimizes the frequency of color misregistration correction, reducing the productivity loss of the image forming apparatus 1. If color misregistration correction is to be performed (YES in step S39), the process proceeds to Step S40. If not (NO in step S39), the density adjustment processing ends

### Step S40

Then, the controller 10 generates a request to execute color misregistration correction. Then, the density adjustment processing ends.

### Color Registration of Image Forming Apparatus

FIG. 18 is a flowchart of a color registration process of the image forming apparatus in FIG. 1. Referring to FIG. 18, the color registration of the image forming apparatus 1 according to the present embodiment is described below. When a request for color misregistration correction is generated during the operation of the image forming apparatus 1, the following color registration is executed at a predetermined timing.

### Step S51

The controller 10 of the image forming apparatus 1 performs pre-detection processing. Then, the process proceeds to step S52.

### Step S52

The controller 10 forms a color registration pattern for color registration. Then, the process proceeds to step S53.

### Step S53

The controller 10 causes the density sensor 45 to detect the toner density of the formed color registration pattern. Then, the process proceeds to step S54.

### Step S54

The controller 10 determines whether the color registration pattern has been successfully detected. If the controller 10 determines that the color registration pattern has been successfully detected (YES in step S54), the process proceeds to step S55. If the controller 10 determines that the color registration pattern has not been successfully detected (NO in step S54), the color registration process ends.

### Step S55

The correction value calculation unit 105 of the controller 10 calculates a correction value based on the detection result of the color registration pattern. Then, the process proceeds to step S56.

### Step S56

The controller 10 determines whether the correction value calculated by the correction value calculation unit 105 is allowable. If the correction value is allowable (YES in step S56), the process proceeds to step S57. If the correction value is not allowable (NO in step S56), the color registration ends.

### Step S57

The correction value calculation unit 105 stores the calculated correction value in the correction value storage unit 112 or updates the correction value stored in the correction value storage unit 112 with the calculated correction value. Then, the process proceeds to step S58.

### Step S58

Then, the gain switching unit 106 stores the gain information, such as the setting of the gain switching signal or resistance value, used during the color registration in the gain switching storage unit 113. The color registration process then ends.

As described above, in the image forming apparatus 1 according to the present embodiment, the laser diode 21 emits a laser beam, which is deflected by the polygon mirror 23 to scan the photoconductor drums 30. The optical sensor 91 detects the laser beam deflected by the polygon mirror 23 to determine the write start timing for forming a latent image. The gain switching circuit 92 adjusts the gain for the optical sensor 91 to detect the laser beam. The controller 10 includes the light emission control unit 102 that controls the intensity of the laser beam emitted from the laser diode 21, and the gain switching unit 106 that switches the gain through the gain switching circuit 92 based on the set light intensity.

When the gain is switched by the gain switching unit 106, the controller 10 determines whether to perform color misregistration correction based on the shift in the write start timing. This minimizes the frequency of color misregistration correction associated with gain switching, thus reducing the productivity loss of the image forming apparatus 1.

### Second Embodiment

An image forming apparatus 1 according to a second embodiment is described below, focusing on the differences from the image forming apparatus 1 according to the first embodiment. In the first embodiment, the gain is switched between two levels for the optical sensor 91. In the present embodiment, the gain for the optical sensor 91 is switched between three or more levels, as described below. The configurations of the image forming apparatus 1 and the optical scanner 20, and the functional blocks of the controller 10 are the same as those in the first embodiment.

### Configuration and Operation of Synchronous Detection Board

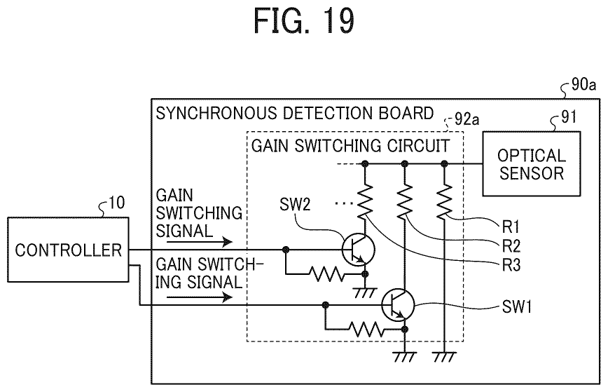

FIG. 19 is a diagram illustrating a configuration of a synchronous detection board in the image forming apparatus according to the second embodiment. Referring to FIGS. 19, the configuration and operation of the synchronous detection board 90a in the image forming apparatus 1 according to the present embodiment are described below.

In the present embodiment, a configuration is described in which two or more types of gain switching signals are input from the controller 10. The number of gain switching signals input from the outside increases with the number of resistors (e.g., R1, R2,.) used in the gain switching circuit. The gain of the gain switching circuit is switched by setting the voltage of each gain switching signal to high level or low level. In this case, the number of gains to be switched is determined according to the maximum 2ⁿ where n is the number of gain switching signals. For example, in the gain switching circuit 92 illustrated in FIG. 8, if the number of gain switching signals is one (n=1), the gain is switched between a maximum of two levels. When the number of gain switching signals is n, the gain is switched among up to 2ⁿ levels. However, since setting all 2ⁿ gain levels to appropriate values is difficult, (n+1) gain levels are selected and used from 2ⁿ gain levels, enabling the image forming apparatus 1 to operate with suitable gain settings. n the present embodiment, a configuration with two gain switching signals (n=2) is described, and the use of (n+1), that is, three gain levels, is described. Thus, by using only preselected gain levels from the maximum of four levels available, the image forming apparatus 1 can operate with optimal gain settings.

As illustrated in FIG. 19, the synchronous detection board 90a includes an optical sensor 91 and a gain switching circuit 92a as an example of a sensitivity switching circuit. The gain switching circuit 92a switches gain to adjust the detection sensitivity of the optical sensor 91 according to two gain switching signals input from the controller 10. The gain switching circuit 92a includes a resistor R1, a resistor R2, a resistor R3, a switching device SW1, and a switching device SW2.

In the synchronous detection board 90a, the gain resistance, which determines the gain of the optical sensor 91. is switched based on two gain switching signals input from the controller 10. The gain switching signals are applied to the bases of the switching device SW1 and the switching device SW2. In the synchronous detection board 90a illustrated in FIG. 19, when both gain switching signals input from the controller 10 are at low level, the gain resistance is set to the value of the resistor R1 (hereinafter referred to as high gain in the present embodiment), corresponding to the third sensitivity level. When the gain switching signal input to the base of the switching device SW1 from the controller 10 is at high level, and the signal input to the base of the switching device SW2 is at low level, the gain resistance becomes the combined resistance of the resistor R1 and the resistor R2 connected in parallel. Its value is 1/(1/R1+1/R2), which is less than R1 (hereinafter referred to as medium gain in the present embodiment), corresponding to the fourth sensitivity level. When both of two gain switching signals input from the controller 10 are at a high voltage level, the gain resistance becomes the combined resistance of the resistor R1, the resistor R2, and the resistor R3 connected in parallel, which is calculated as 1/(1/R1+1/R2+1/R3)<1/(1/R1+1/R2). This is referred to as low gain in the present embodiment (the fifth sensitivity).

In FIG. 19, the gain switching circuit 92a is configured as an external circuit relative to the optical sensor 91, but is not limited to this configuration. This circuit may instead be built into the optical sensor 91. In the following description, the gain switching circuit 92a is described as a circuit externally attached to the optical sensor 91.

### Operation in Case of Switching Gain of Optical Sensor

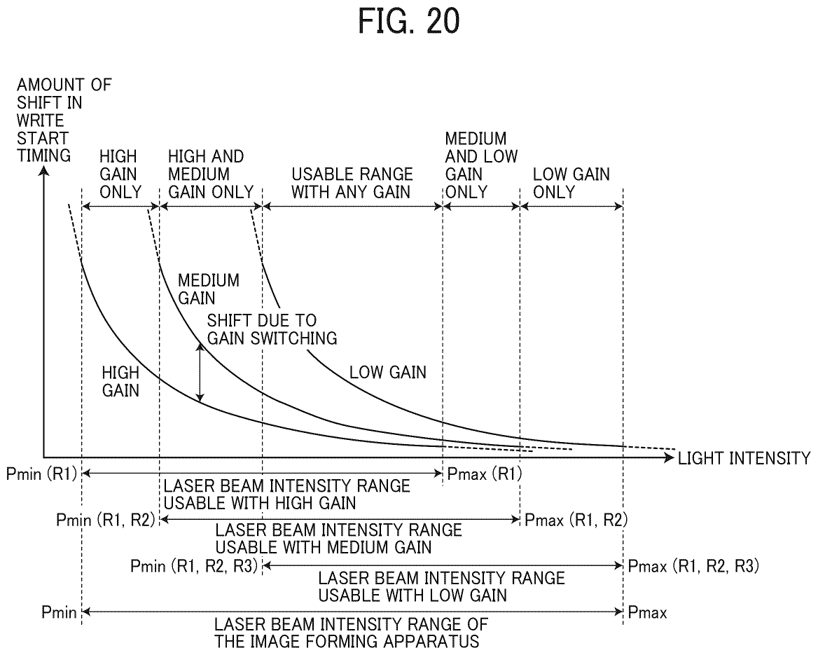

FIG. 20 is a diagram illustrating a shift in write start timing caused by a gain switch in the image forming apparatus according to a second embodiment. Referring to FIG. 20, the gain switching of the optical sensor 91 on the synchronous detection board 90a, controlled by the controller 10 of the image forming apparatus 1, is described.

As described above, the gain switching circuit 92a switches between three gain levels

In the operation of the image forming apparatus 1, the minimum and maximum intensities of the laser beam incident on the optical sensor 91 are defined as Pₘᵢₙ and Pₘₐₓ, respectively. The combination of resistance values for the resistors R1 to R3 to be used is determined. A relational expression is established for each pair of adjacent gain levels: high gain and medium gain; and medium gain and low gain. Pₘᵢₙ(R1) and Pₘₐₓ(R1) denote the minimum and maximum detectable laser beam intensities when the gain resistance is set to the value of the resistor R1 (high gain). The minimum and maximum values of the resistor R1 are defined as R1ₘᵢₙ and R1ₘₐₓ, respectively, and the minimum and maximum values of the resistor R2 are defined as R2ₘᵢₙ and R2ₘₐₓ, respectively. Further, the minimum and maximum values of the resistor 3 are defined as R3ₘᵢₙ and R3ₘₐₓ. In this case, the following Equations (10) and (11) hold. The MIN function in equation (10) returns the smaller value of its arguments.

Pₘᵢₙ(R1)/MIN(Pₘₐₓ/α^{n-1-i (i=1)}, Pₘₐₓ(R1))×R1ₘₐₓ≤1/(1/R1ₘₐₓ+1/R2ₘᵢₙ) . . . (10)

1/(1/R1ₘᵢₙ+1/R2ₘₐₓ)≤Pₘₐₓ (R1)/(Pₘₐₓ/α^{n-1-i (i=1)})×R1ₘᵢₙ . . . (11)

The coefficient α in the above Equations (10) and (11) is a value represented by the following Equation (12). In the present embodiment, the coefficient α is set to equalize the ratio of medium gain to high gain and the ratio of low gain to medium gain, thus maximizing the overlapping ranges among the gains.

α=n−1\sqrt{ } (Pₘₐₓ/Pₘₐₓ(R1)) . . . (12)

By transforming equations (10) and (11), the following equations (13) and (14) are obtained (where n=2).

Pₘᵢₙ(R1)/(MIN(Pₘₐₓ/α, Pₘₐₓ(R1))−Pₘᵢₙ(R1))×R1ₘₐₓ≤R2ₘᵢₙ . . . (13)

R2ₘₐₓ≤(α×Pₘₐₓ(R1))/(Pₘₐₓ−α×Pₘₐₓ(R1))×R1ₘᵢₙ . . . (14)

Similarly, a relational expression can be established for the combination of medium gain and low gain. When the gain resistor is set to medium gain (or the combined resistance value of the resistor R1 and the resistor R2), and the minimum and maximum values of the detectable laser beam intensity range are defined as Pₘᵢₙ(R1, R2) and Pₘₐₓ(R1,R2) respectively, the following Equations (15) and (16) hold.

Pₘᵢₙ(R1, R2)/MIN (Pₘₐₓ/α^{n-1-i (i=2)}, Pₘₐₓ(R1, R2))×1/(1/R1ₘₐₓ+1/R2ₘᵢₙ)≤1/(1/R1ₘₐₓ+1/R2ₘᵢₙ+1/R3ₘᵢₙ) . . . (15)

1/(1/R1ₘᵢₙ+1/R2ₘₐₓ+1/R3ₘₐₓ)≤Pₘₐₓ(R1, R2)/(Pₘₐₓ/α^{n-1-i (i=2)})×1/(1/R1ₘᵢₙ+1/R2ₘₐₓ) . . . (16)

By transforming equations (15) and (16), the following equations (17) and (18) are obtained.

Pₘᵢₙ(R1, R2)/((MIN(Pₘₐₓ, Pₘₐₓ(R1, R2))−Pₘᵢₙ(R1, R2))×(1/R1ₘₐₓ+1/R2ₘᵢₙ))≤R3ₘᵢₙ . . . (17)

R3ₘₐₓ≤(Pₘₐₓ(R1, R2))/((Pₘₐₓ−Pₘₐₓ(R1, R2))×(1/R1ₘᵢₙ+1/R2ₘₐₓ)) . . . (18)

At this time, it is preferable for the values of the resistors R2 and R3 to be as close as possible to their respective maximum values R2ₘₐₓ and R3ₘₐₓ, respectively. As the values of the resistors R2 and R3 approach R2ₘₐₓ and R3ₘₐₓ, respectively, the shift between the gain curves decreases, and the usable range for each gain becomes wider. This reduces the frequency of gain switching and the frequency of color misregistration correction associated with gain switching.

Even if the number of gain switching signals increases, the calculation method is the same as the above-described calculation method. That is, by calculating the values of the resistors R2, R3, and so on, starting from the resistor R1, it is possible to determine a combination of resistor values that maximizes the usable laser beam intensity range for any gain.

As described above, it is preferable for the values of the resistors R2 and R3 to be as close as possible to their respective maximum values R2ₘₐₓ and R3ₘₐₓ, respectively. Ideally, the resistors R2 and R3 should be set to the maximum values R2ₘₐₓ and R3ₘₐₓ. However, commercially available resistors R2 and R3 are limited in variety, and their resistance values are restricted to predetermined standard values. Accordingly, it is not practical to directly use the calculated values R2ₘₐₓ and R3ₘₐₓ without modification. Further, since resistors themselves have manufacturing tolerances, the resistors R2 and R3 must be selected with these variations in mind. It is practical to select the resistors R2 and R3 with resistance values as close as possible to R2ₘₐₓ and R3ₘₐₓ, respectively. However, even if the ideal resistance values R2ₘₐₓ and R3ₘₐₓ cannot be adopted, the above effect can still be achieved by using the resistors R2 and R3 with values close to R2ₘₐₓ and R3ₘₐₓ. Furthermore, if the ratio of medium gain to high gain is substantially equal to the ratio of low gain to medium gain, it can be determined that the above effect has been achieved.

In the present embodiment, the calculations were performed for three cases: (1) when both gain switching signals are at a low voltage level, (2) when the gain switching signal input to the base of the switching device SW1 is at a high level and the signal input to the switching device SW2 is at a low level, and (3) when both signals are at a high level voltage. However, a configuration in which the signal input to the base of the switching device SW1 is at a low level and the signal input to the base of the switching device SW2 is at a high level may also be used. In other words, as long as the combined resistance value matches the target value, the above effects can be achieved even if the combination of gain switching signals is changed.

### Operation in Case of Switching Gain of Optical Sensor

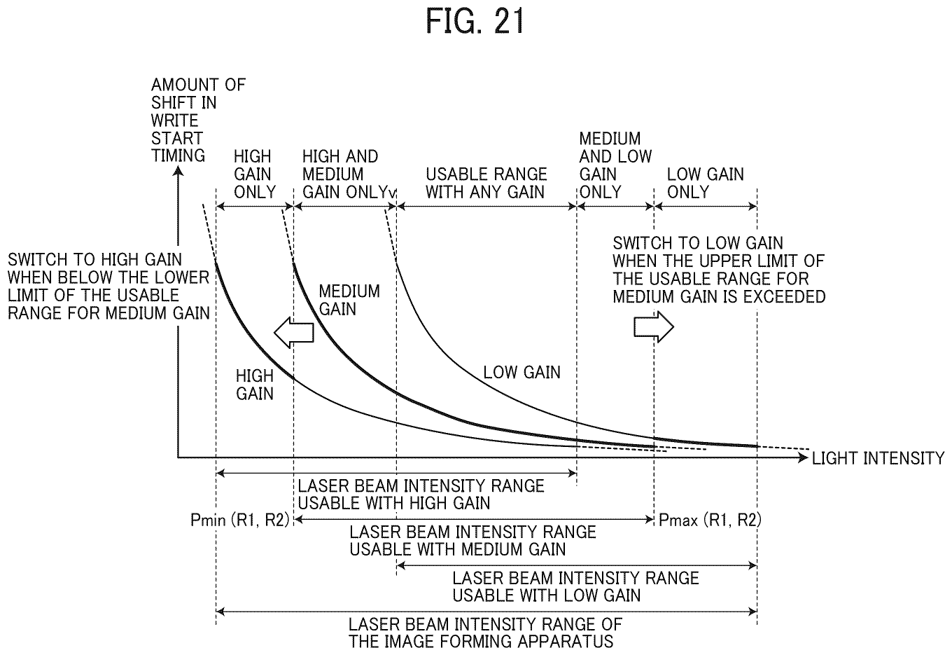

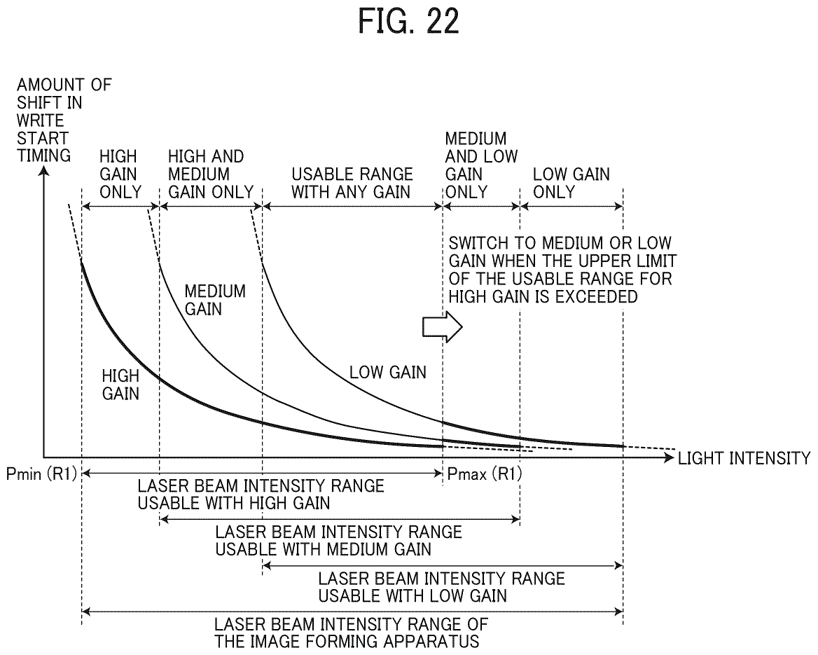

FIG. 21 is a diagram illustrating the switching of gain resistance from middle gain to low gain or high gain in the image forming apparatus of FIG. 19. FIG. 22 is a diagram illustrating the switching of gain resistance from high gain to middle gain or low gain in the image forming apparatus of FIG. 19. Referring to FIGS. 21 and 22, the gain switching of the optical sensor 91 on the synchronous detection board 90a, controlled by the controller 10 of the image forming apparatus 1, is described.

The initial state is set with the optical sensor 91 operating at medium gain, with the gain resistance set to the combined resistance value of the resistor R1 and the resistor R2. In the operation of the image forming apparatus 1, when the intensity of the laser beam emitted from the laser diode 21 is set to exceed Pₘₐₓ(R1, R2), which is the maximum usable laser beam intensity at the optical sensor 91, the gain switching unit 106 switches the gain of the optical sensor 91 to low gain, as illustrated in FIG. 21. In the operation of the image forming apparatus 1, when the intensity of the laser beam emitted from the laser diode 21 is set to fall below Pₘᵢₙ(R1, R2), which is the minimum usable laser beam intensity at the optical sensor 91, the gain switching unit 106 switches the gain of the optical sensor 91 to high gain, as illustrated in FIG. 21.

As described above, when operating at an intermediate gain (or, the medium gain) among multiple gain levels, the threshold light intensities for switching to other gain levels are set separately for the upper and lower sides. As illustrated in FIG. 21, continuing to use the currently set gain as much as possible up to the upper and lower limits of the usable laser beam intensity range for each gain minimizes the frequency of gain switching, reduces supply costs, and prevents a decline in the productivity of the image forming apparatus 1.

In the present embodiment, the controller 10 determines whether to execute color misregistration correction when switching the gain. That is, when the gain switching unit 106 switches from high gain to low gain, the controller 10 may determine that the shift in write start timing is within the allowable range and may not execute the color misregistration correction. When the gain switching unit 106 switches from low gain to high gain, the controller 10 may determine that the shift in write start timing is not within the allowable range and may perform the color misregistration correction. The color misregistration correction is performed only when the controller 10 determines that the correction is to be performed. This reduces a decline in the productivity of the image forming apparatus 1.

The initial state is set with the optical sensor 91 operating at high gain, with the gain resistance set to the value of resistor R1. In the operation of the image forming apparatus 1, when the intensity of the laser beam emitted from the laser diode 21 is set to exceed Pₘₐₓ(R1), which is the maximum usable laser beam intensity at the optical sensor 91, the gain switching unit 106 switches the gain of the optical sensor 91 to medium gain or low gain, as illustrated in FIG. 22. In this case, unlike FIG. 21, the gain switching unit 106 involves selecting an optimal gain to which the gain is to be switched.

First, the gain switching unit 106 switches the gain from high gain to low gain when the setting value of the laser beam intensity of the laser diode 21 has changed and the laser beam intensity at the optical sensor 91 falls within the “LOW GAIN ONLY” range illustrated in FIG. 22. This is because proper operation is possible when using low gain.

Next, the gain switching unit 106 selects an optimal gain from medium gain and low gain when the setting value of the laser beam intensity of the laser diode 21 has changed and the laser beam intensity at the optical sensor 91 falls within the “MEDIUM AND LOW GAIN ONLY” range illustrated in FIG. 22. The gain switching unit 106 determines which range includes the currently set laser beam intensity. For example, if the currently set laser beam intensity falls within the “HIGH AND MEDIUM GAIN ONLY” range illustrated in FIG. 22, and the gain is switched to the medium gain, then both the current intensity and the intensity after the setting change will fall within the usable range with any gain. In this case, the gain switching unit 106 switches from the high gain to the medium gain. This is because the laser beam intensity may return to the currently set value. The laser beam intensity varies due to environmental changes such as temperature or humidity. If a significant amount of time has passed since the previous density adjustment operation and the environment has changed substantially, it is expected that the currently set laser beam intensity and the intensity after the setting change may differ significantly, as described above. It is also possible that the environment may return to a state where the currently set laser beam intensity is more suitable. If both the currently set laser beam intensity and the intensity after the setting change can be handled with the same gain (in this case, the medium gain), then gain switching becomes unnecessary even if environmental changes such as temperature or humidity occur in the usage environment of the image forming apparatus 1. In other words, there is no need to perform color misregistration correction each time the gain is switched, thus reducing the decrease in productivity of the image forming apparatus 1.

However, if the laser beam intensity at the optical sensor 91 after the light intensity of the laser diode 21 has been changed falls within the “MEDIUM AND LOW GAIN ONLY” range illustrated in FIG. 22, while the currently set laser beam intensity falls within either the “USABLE RANGE WITH ANY GAIN” range or the “HIGH GAIN ONLY” range, it becomes impossible to determine whether switching to the medium gain or the low gain is more appropriate. In this case, the gain switching unit 106 performs another determination process. Specifically, the gain switching unit 106 determines which center of the usable intensity ranges after gain switching is closest to the center of the laser beam intensity range after the setting change, and switches the gain to the one whose range is closest to the center of the usable intensity range selected. In the case of the medium gain, the usable laser beam intensity range is from Pₘᵢₙ(R1, R2) to Pₘₐₓ(R1, R2), and in the case of the low gain, the usable laser beam intensity range is from Pₘᵢₙ(R1, R2, R3) to Pₘₐₓ(R1, R3, R3). When the laser beam intensity range after the setting change is P (Now), the gain switching unit 106 switches the gain to the smaller value determined by Equations (19) and (20). The ABS function in Equations (19) and (20) is a function that returns the absolute value of its argument.

ABS((Pₘₐₓ(R1, R2)+Pₘᵢₙ(R1, R2))/2−P(Now)) . . . (19)

ABS((Pₘₐₓ(R1, R2, R3)+Pₘᵢₙ(R1, R2, R3))/2−P(Now)) . . . (20)

Using at least one of the above determinations minimizes the frequency of gain switching and color misregistration correction, reducing the productivity loss of the image forming apparatus 1. These determination processes are executed in step S38 illustrated in FIG. 17 described above.

That is, in FIG. 21, when the gain switching unit 106 switches from high gain to low gain, the controller 10 may determine that the shift in write start timing is within the allowable range and may not execute the color misregistration correction. However, in practice, as illustrated in FIG. 22, switching the gain causes a noticeable shift in the write start timing. As the difference in gain resistance before and after switching increases, the shift also becomes greater. The controller 10 determines whether the shift in the write start timing caused by gain switching is within the allowable range. The controller 10 may skip the color misregistration correction when determining that the shift in the writing start timing caused by gain switching is within the allowable range, and may execute the color misregistration correction when determining the shift exceeds the allowable range. For example, the shift in write start timing that occurs when switching from high gain to medium gain, as illustrated in FIG. 22, may be considered within the allowable range, whereas the shift that occurs when switching from high gain to low gain may be regarded as outside the allowable range. In addition, in order to estimate the shift in write start timing caused by gain switching, information on the gain before switching (such as the setting of the gain switching signal or resistance value) may be stored in the gain switching storage unit 113. This gain information is updated when the color misregistration correction is successfully completed. This minimizes the frequency of color misregistration correction, reducing the productivity loss of the image forming apparatus 1.

### Gain Switching In Multiple Operation Modes

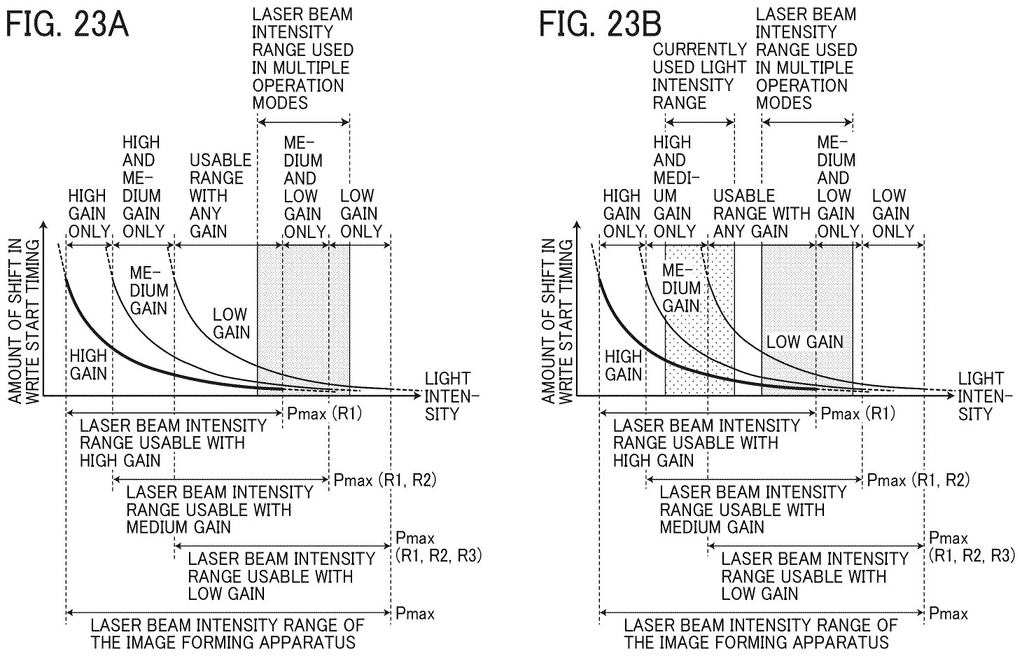

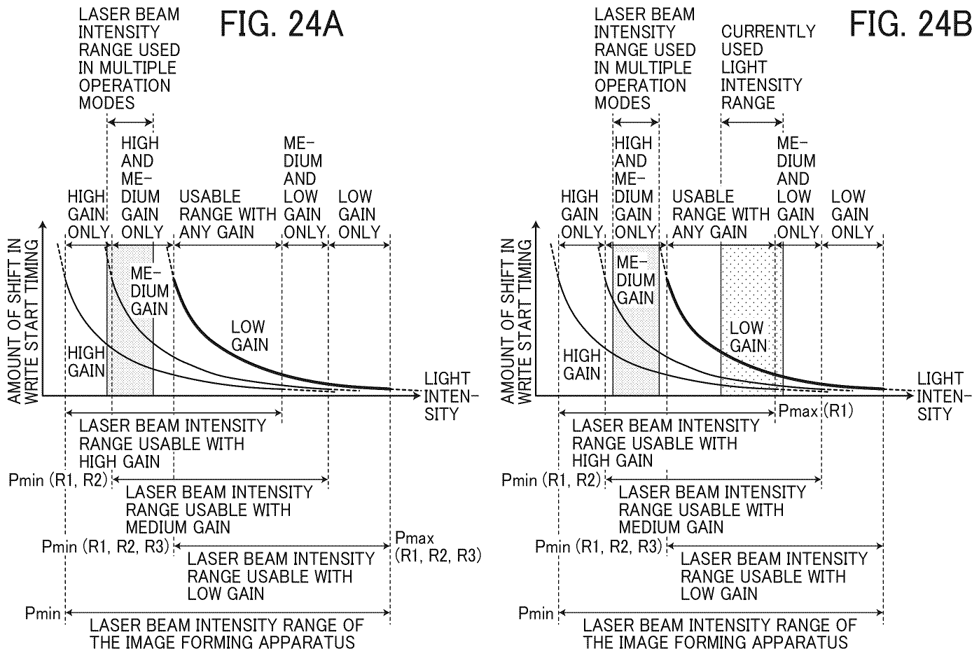

FIGS. 23A and 23B are diagrams illustrating the switching of gain resistance from high gain to middle gain or low gain in the image forming apparatus of FIG. 19, operating in multiple modes. FIGS. 24A and 24B are diagrams illustrating the switching of gain resistance from low gain to middle gain or high gain in the image forming apparatus of FIG. 19, operating in multiple modes. The following describes how the controller 10 of the image forming apparatus 1 switches the gain resistance in multiple operation modes, with reference to FIGS. 23A, 23B, 24A, and 24B.

To avoid such a situation, as in FIGS. 15A and 15B, when the laser diode 21 is controlled to emit light by the light emission control unit 102 with different laser beam intensity settings in the multiple operation modes of the image forming apparatus 1, the resistance values of the resistors R1 to R3 in the gain switching circuit 92 are selected to enable the optical sensor 91 to operate without gain switching in all operation modes, with at least one available gain setting. When switching the gain of the optical sensor 91, the gain switching unit 106 selects a gain that eliminates the need for further switching across all operation modes. This allows mode switching without gain switching or color misregistration correction, even when different laser beam intensities are used in different operation modes of the image forming apparatus 1, thus reducing a decline in the productivity of the image forming apparatus 1.

The “laser beam intensity ranges usable with multiple operation modes” illustrated in FIGS. 23A and 23B indicate the laser beam intensity range used in each operation mode, which are switched according to the current environmental conditions such as temperature and humidity. The current gain of the optical sensor 91 is assumed to be high gain. Due to the density adjustment operation of the image forming apparatus 1, the intensity of the laser beam used changes, and the intensity of laser beam incident on the optical sensor 91 varies accordingly.

For example, it is assumed that the laser beam intensity range has changed to the laser beam intensity range used in multiple operation modes illustrated in FIG. 23A. In this case, the “laser beam intensity range used in multiple operation modes” fall within the laser beam intensity range (or a light intensity range) usable with low gain. To prevent the gain used from switching across different operation modes of the image forming apparatus 1, the gain switching unit 106 switches from high gain to low gain.

Further, it is assumed that the laser beam intensity range has changed to the laser beam intensity range used in multiple operation modes illustrated in FIG. 23B. In this case, since the “laser beam intensity range used in multiple operation modes” fall within both the laser beam intensity range usable with medium gain and the laser beam intensity range usable with low gain, the gain switching unit 106 can switch from high gain to either medium or low gain to prevent the gain from changing across different operation modes of the image forming apparatus 1. In this case, the gain switching unit 106 switches the gain to the optimal gain by the same determination processing as that in FIG. 22. That is, the gain switching unit 106 determines which range includes the currently set laser beam intensity range. In FIG. 23B, the currently set laser beam intensity range (the range currently in use) falls within the laser beam intensity range usable with medium gain, but falls outside the laser beam intensity range usable with low gain. In this case, the gain switching unit 106 switches from the high gain to the medium gain.

If the gain switching unit 106 fails to determine which to switch to, medium gain or low gain, through the above determination, the gain switching unit 106 performs another determination process, as in FIG. 22. Specifically, the gain switching unit 106 determines which center of the usable intensity ranges after gain switching is closest to the center of the laser beam intensity range after the setting change, and switches the gain to the one whose range is closest to the center of the usable intensity range selected. In the case of the medium gain, the usable laser beam intensity range is from Pₘᵢₙ(R1, R2) to Pₘₐₓ(R1, R2), and in the case of the low gain, the usable laser beam intensity range is from Pₘᵢₙ(R1, R2, R3) to Pₘₐₓ(R1, R3, R3). When the laser beam intensity range after the setting change is from Pₘᵢₙ(Now) to Pₘₐₓ(Now), the gain switching unit 106 switches the gain to the smaller value determined by Equations (21) and (22). The ABS function in Equations (21) and (22) is a function that returns the absolute value of its argument.

ABS((Pₘₐₓ(R1, R2)+Pₘᵢₙ(R1, R2))/2−(Pₘₐₓ(Now)+Pₘᵢₙ(now))/2) . . . (21)

ABS((Pₘₐₓ(R1, R2, R3)+Pₘᵢₙ(R1, R2, R3))/2−(Pₘₐₓ(Now)+Pₘᵢₙ(now))/2) . . . (22)

Using at least one of the above determinations minimizes the frequency of gain switching and color misregistration correction, reducing the productivity loss of the image forming apparatus 1. These determination processes are executed in step S38 illustrated in FIG. 17 described above.

As in the case illustrated in FIGS. 21 and 22 described above, the controller 10 may skip the color misregistration correction when the shift in the writing start timing caused by gain switching is within the allowable range, and may execute the color misregistration correction when the shift exceeds the allowable range.

The “laser beam intensity ranges usable with multiple operation modes” illustrated in FIGS. 24A and 24B indicate the laser beam intensity range used in each operation mode, which are switched according to the current environmental conditions such as temperature and humidity. The current gain of the optical sensor 91 is assumed to be low gain. Due to the density adjustment operation of the image forming apparatus 1, the intensity of the laser beam used changes, and the intensity of laser beam incident on the optical sensor 91 varies accordingly. In this case as well, the gain switching unit 106 switches to the optimal gain based on the same criteria described above in FIGS. 23A and 23B.

For example, it is assumed that the laser beam intensity range has changed to the laser beam intensity range used in multiple operation modes illustrated in FIG. 24A. In this case, the “laser beam intensity range used in multiple operation modes” fall within the range where high gain can be used. To prevent the gain used from switching across different operation modes of the image forming apparatus 1, the gain switching unit 106 switches from low gain to high gain.

Further, it is assumed that the laser beam intensity range has changed to the laser beam intensity range used in multiple operation modes illustrated in FIG. 24B. In this case, since the “laser beam intensity range used in multiple operation modes” fall within both the laser beam intensity range usable with medium gain and the laser beam intensity range usable with high gain, the gain switching unit 106 can switch from low gain to either medium or high gain to prevent the gain from changing across different operation modes of the image forming apparatus 1. In this case, the gain switching unit 106 switches the gain to the optimal gain by the same determination processing as that in FIG. 22. That is, the gain switching unit 106 determines which range includes the currently set laser beam intensity range. In FIG. 24B, the currently set laser beam intensity range (the range currently in use) falls within the laser beam intensity range usable with medium gain, but falls outside the laser beam intensity range usable with high gain. In this case, the gain switching unit 106 switches from low gain to medium gain.

If the gain switching unit 106 fails to determine which to switch to, medium gain or high gain, through the above determination, the gain switching unit 106 performs another determination process, as in FIG. 22. Specifically, the gain switching unit 106 determines which center of the usable intensity ranges after gain switching is closest to the center of the laser beam intensity range after the setting change, and switches the gain to the one whose range is closest to the center of the usable intensity range selected. In the case of the medium gain, the usable laser beam intensity range is from Pₘᵢₙ(R1, R2) to Pₘₐₓ(R1, R2), and in the case of the high gain, the usable laser beam intensity range is from Pₘᵢₙ(R1) to Pₘₐₓ(R1). When the laser beam intensity range after the setting change is from Pₘᵢₙ(Now) to Pₘₐₓ(Now), the gain switching unit 106 switches the gain to the smaller value determined by Equations (23) and (24). The ABS function in Equations (23) and (24) is a function that returns the absolute value of its argument.

ABS ((Pₘₐₓ(R1)+Pₘᵢₙ(R1))/2−(Pₘₐₓ(Now)+Pₘᵢₙ(Now))/2) . . . (23)

ABS ((Pₘₐₓ(R1, R2)+Pₘᵢₙ(R1, R2))/2−(Pₘₐₓ(Now)+Pₘᵢₙ(now))/2) . . . (24)

Using at least one of the above determinations minimizes the frequency of gain switching and color misregistration correction, reducing the productivity loss of the image forming apparatus 1. These determination processes are executed in step S38 illustrated in FIG. 17 described above.

In the above-described embodiments, when at least one of the functional units of the controller 10 is implemented by executing a program, the program is provided by being incorporated in a ROM or the like in advance. Alternatively, in the embodiments described above, the program that is executed by the controller 10 of the image forming apparatus 1 of the control device 1 may be stored in a computer-readable recording medium in an installable or executable file format so that the program can be provided. Examples of the computer-readable recording medium include, but are not limited to, a CD-ROM, a flexible disk (FD), a CD-R, and a DVD. Alternatively, in the embodiments described above, the program that is executed by the control device 1 of the image forming apparatus 1 may be stored on a computer connected to a network such as the Internet so that the program can be downloaded through the network and provided. Alternatively, in the embodiments described above, the program that is executed by the controller 10 of the image forming apparatus I may be provided or distributed through a network such as the Internet. A program to be executed by the controller 10 of the image forming apparatus 1 according to the above embodiments of the present disclosure and their modification has module structure including at least one of the above-described functional units. Regarding the actual hardware related to the program, the CPU reads and executes the program from the memory as described above to load the program onto the main memory to implement the above multiple functional units.

Aspects of the present disclosure are as follows.

### Aspect 1

An image forming apparatus includes a light emitter to emit light; a photoconductor to form a latent image on a surface of the photoconductor by the light emitted from the light emitter; a deflector to deflect the light emitted from the light emitter to scan the light on the surface of the photoconductor at a write start timing; an optical sensor; and circuitry. The optical sensor detects the light scanning on the surface of the photoconductor with one of multiple sensitivities; and outputs a detection signal corresponding to a light intensity of the light detected by the optical sensor. The circuitry adjusts a light intensity of the light emitted from the light emitter and the write start timing based on the detection signal; switches from the one of multiple sensitivities to other of multiple sensitivities or from the other of multiple sensitivities to the one of multiple sensitivities based on the light intensity adjusted; and determines whether to perform a color misregistration correction based on a shift in the write start timing caused by a switch from the one of multiple sensitivities to the other of multiple sensitivities or from the other of multiple sensitivities to the one of multiple sensitivities.

### Aspect 2

In the image forming apparatus according to Aspect 1, the other of multiple sensitivities is lower than the one of multiple sensitivities, and the circuitry is further configured to determine not to perform the color misregistration correction in response to the switch from the one of multiple sensitivities to the other of multiple sensitivities.

### Aspect 3

In The image forming apparatus according to Aspect 1, the other of multiple sensitivities is lower than the one of multiple sensitivities, and the circuitry is further configured to determine to perform the color misregistration correction in response to the switch from the other of multiple sensitivities to the one of multiple sensitivities.

### Aspect 4

In the image forming apparatus according to any one of Aspects 1 to 3, the other of multiple sensitivities is lower than the one of multiple sensitivities, and the circuitry is further configured to: determine whether a set light intensity set to the light emitter exceeds a first light intensity that is a maximum value of a first light intensity range usable with the one of multiple sensitivities; determine whether the set light intensity is below a second light intensity that is a minimum value of a second light intensity range usable with the other of multiple sensitivities; switch from the one of multiple sensitivities to the other of multiple sensitivities when the set light intensity exceeds the first light intensity; and switch from the other of multiple sensitivities to the one of multiple sensitivities when the set light intensity is below the second light intensity.

### Aspect 5

In the image forming apparatus according to Aspect 4, the circuitry is further configured to: switch between the one of multiple sensitivities and the other of multiple sensitivities lower than the one of multiple sensitivities; and obtain the first light intensity by: multiplying a maximum light intensity used in the image forming apparatus by the second sensitivity; and dividing the maximum light intensity, multiplied by the second sensitivity, by the first sensitivity.

### Aspect 6

In the image forming apparatus according to any one of Aspects 1, the image forming apparatus operates in multiple operation modes with different light intensities of the light emitted from the light emitter, and the circuitry selects at least one sensitivity for the optical sensor to allow the image forming apparatus to operate in the multiple operation modes without the switching.

### Aspect 7

In the image forming apparatus according to Aspect 6, wherein the circuitry selects a sensitivity for the optical sensor to allow the image forming apparatus to operate in the multiple operation modes without further switching.

### Aspect 8

In the image forming apparatus according to Aspect 5, the image forming apparatus operates in multiple operation modes with different light intensities of the light emitted from the light emitter, and the circuitry selects a combination of the one of multiple sensitivities and the other of multiple sensitivities to obtain a value that is greater than a ratio of a maximum light intensity to a minimum light intensity used across the multiple operation modes, the value being obtained by dividing a maximum light intensity used in the image forming apparatus by a minimum light intensity usable at the other of multiple sensitivities, and multiplying by square of a ratio of the other of multiple sensitivities to the one of multiple sensitivities.

### Aspect 9

In the image forming apparatus according to any one of Aspects 1 to 8, the circuity is further configured to switch between three or more sensitivities; determine whether a detection-enabled sensitivity is present that enables detection of both a first light intensity before setting change and a second light intensity after setting change, emitted from the light emitter; and select the detection-enabled sensitivity for the optical sensor, in response to the setting change of the light intensity of the light emitter, based on a determination that the detection-enabled sensitivity is present.

### Aspect 10

In the image forming apparatus according to Aspect 9, the circuitry is further configured to: determine which center of light intensity range the second light intensity is closest to among light intensity ranges for different sensitivities, based on a determination that the detection-enabled sensitivity is not present; and select a sensitivity corresponding to a light intensity range having a center closest to the second light intensity, for the optical sensor.

### Aspect 11

In the image forming apparatus according to any one of Aspects 1 to 10, the circuitry is further configured to determine whether a shift in the write start timing caused by the switch is within an allowable range; and perform the color misregistration correction based on a determination that the shift is within an allowable range.

### Aspect 12

In the image forming apparatus according to any one of Aspects 1 to 11, the circuitry includes: a resistor connected to the optical sensor; and a switch to selectively allow current to flow to the resistor in response to a signal.

### Aspect 13

In the image forming apparatus according to any one of Aspects 1 to 3, the first circuitry switches between a third sensitivity, a fourth sensitivity lower than the third sensitivity, and fifth sensitivity lower than the fourth sensitivity, and a ratio of the fourth sensitivity to the third sensitivity is substantially equal to a ratio of the fifth sensitivity to the fourth sensitivity.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. An image forming apparatus comprising:
a light emitter to emit light;
a photoconductor to form a latent image on a surface of the photoconductor by the light emitted from the light emitter;
a deflector to deflect the light emitted from the light emitter to scan the light on the surface of the photoconductor at a write start timing;
an optical sensor to:
detect the light scanning on the surface of the photoconductor with one of multiple sensitivities; and
output a detection signal corresponding to a light intensity of the light detected by the optical sensor; and
circuitry configured to:
adjust a light intensity of the light emitted from the light emitter and the write start timing based on the detection signal;
switch from the one of multiple sensitivities to other of multiple sensitivities or from the other of multiple sensitivities to the one of multiple sensitivities based on the light intensity adjusted; and
determine whether to perform a color misregistration correction based on a shift in the write start timing caused by a switch from the one of multiple sensitivities to the other of multiple sensitivities or from the other of multiple sensitivities to the one of multiple sensitivities.

2. The image forming apparatus according to claim 1,
wherein the other of multiple sensitivities is lower than the one of multiple sensitivities, and
the circuitry is further configured to determine not to perform the color misregistration correction in response to the switch from the one of multiple sensitivities to the other of multiple sensitivities.

3. The image forming apparatus according to claim 1,
wherein the other of multiple sensitivities is lower than the one of multiple sensitivities, and
the circuitry is further configured to determine to perform the color misregistration correction in response to the switch from the other of multiple sensitivities to the one of multiple sensitivities.

4. The image forming apparatus according to claim 1,
wherein the other of multiple sensitivities is lower than the one of multiple sensitivities, and
the circuitry is further configured to:
determine whether a set light intensity set to the light emitter exceeds a first light intensity that is a maximum value of a first light intensity range usable with the one of multiple sensitivities;
determine whether the set light intensity is below a second light intensity that is a minimum value of a second light intensity range usable with the other of multiple sensitivities;
switch from the one of multiple sensitivities to the other of multiple sensitivities when the set light intensity exceeds the first light intensity; and
switch from the other of multiple sensitivities to the one of multiple sensitivities when the set light intensity is below the second light intensity.

5. The image forming apparatus according to claim 4,
wherein the circuitry is further configured to:
switch between the one of multiple sensitivities and the other of multiple sensitivities lower than the one of multiple sensitivities; and
obtain the first light intensity by:
multiplying a maximum light intensity used in the image forming apparatus by the second sensitivity; and
dividing the maximum light intensity, multiplied by the second sensitivity, by the first sensitivity.

6. The image forming apparatus according to claim 1,
wherein the image forming apparatus operates in multiple operation modes with different light intensities of the light emitted from the light emitter, and
the circuitry selects at least one sensitivity for the optical sensor to allow the image forming apparatus to operate in the multiple operation modes without the switching.

7. The image forming apparatus according to claim 6,
wherein the circuitry selects a sensitivity for the optical sensor to allow the image forming apparatus to operate in the multiple operation modes without further switching.

8. The image forming apparatus according to claim 1,
wherein the image forming apparatus operates in multiple operation modes with different light intensities of the light emitted from the light emitter, and
the circuitry selects a combination of the one of multiple sensitivities and the other of multiple sensitivities to obtain a value that is greater than a ratio of a maximum light intensity to a minimum light intensity used across the multiple operation modes, the value being obtained by dividing a maximum light intensity used in the image forming apparatus by a minimum light intensity usable at the other of multiple sensitivities, and multiplying by square of a ratio of the other of multiple sensitivities to the one of multiple sensitivities.

9. The image forming apparatus according to claim 1,
wherein the circuity is further configured to:
switch between three or more sensitivities;
determine whether a detection-enabled sensitivity is present that enables detection of both a first light intensity before setting change and a second light intensity after setting change, emitted from the light emitter; and
select the detection-enabled sensitivity for the optical sensor, in response to the setting change of the light intensity of the light emitter, based on a determination that the detection-enabled sensitivity is present.

10. The image forming apparatus according to claim 9,
wherein the circuitry is further configured to:
determine which center of light intensity range the second light intensity is closest to among light intensity ranges for different sensitivities, based on a determination that the detection-enabled sensitivity is not present; and
select a sensitivity corresponding to a light intensity range having a center closest to the second light intensity, for the optical sensor.

11. The image forming apparatus according to claim 1,
wherein the circuitry is further configured to:
determine whether a shift in the write start timing caused by the switch is within an allowable range; and
perform the color misregistration correction based on a determination that the shift is within an allowable range.

12. The image forming apparatus according to claim 1,
wherein the circuitry includes:
a resistor connected to the optical sensor; and
a switch to selectively allow current to flow to the resistor in response to a signal.

13. The image forming apparatus according to claim 1,
wherein the first circuitry switches between a third sensitivity, a fourth sensitivity lower than the third sensitivity, and fifth sensitivity lower than the fourth sensitivity, and
a ratio of the fourth sensitivity to the third sensitivity is substantially equal to a ratio of the fifth sensitivity to the fourth sensitivity.
